(19) United States
(12) Patent Application Publication
(10) Pub. No.: US 2026/0278922 A1
(43) Pub. Date: Sep. 17, 2026

(54) UTILIZING DIFFUSION MODELS WITH THREE-DIMENSIONAL GAUSSIAN POINT CLOUDS TO GENERATE MULTI-VIEW IMAGES FROM A DIGITAL IMAGE

(71) Applicant: Adobe Inc., San Jose, CA (US)

(72) Inventors: Yuanhao Cai, Baltimore, MD (US); He Zhang, San Jose, CA (US); Kai Zhang, San Jose, CA (US); Mengwei Ren, San Jose, CA (US); Fujun Luan, Santa Clara, CA (US); Qing Liu, Santa Clara, CA (US); Soo Ye Kim, Daejeon (KR); Jianming Zhang, Campbell, CA (US); Zhifei Zhang, San Jose, CA (US); Yuqian Zhou, Seattle, WA (US); Zhe Lin, Fremont, CA (US)

(21) Appl. No.: 19/077,723

(22) Filed: Mar. 12, 2025

(51) Int. Cl. G06T 17/00; G06T 5/70; H04N 13/279

(52) U.S. Cl. CPC G06T 17/00; G06T 5/70; H04N 13/279; G06T 2207/20081; G06T 2207/20084

(57) ABSTRACT

This disclosure describes one or more implementations of systems, non-transitory computer-readable media, and methods that utilize a diffusion model to novel views of an entity depicted in a prompt image from a prompt view. For example, one or more implementations involve receiving a prompt image depicting a visual entity from a first viewpoint. Furthermore, one or more implementations involve generating, utilizing a diffusion model with an input camera condition and the prompt image, three-dimensional Gaussian point clouds representing the visual entity from a second viewpoint. Additionally, one or more implementations involve utilizing the 3D Gaussian point clouds to generate a new image depicting the visual entity from the second viewpoint.

### BACKGROUND

In recent years, there has been an increase in the utilization of machine learning models for digital content creation. For example, individuals and businesses increasingly utilize computing devices with machine learning models to generate new images. As an example, many existing systems utilize a prompt image to generate multi-view new image that depicts the subject of the prompt image from a different viewpoint. Although many existing systems generate multi-view images from a prompt image, many of these existing systems have a number of shortcomings, particularly with regards to accurately, efficiently, and flexibly when generating multi-view images.

### SUMMARY

This disclosure describes one or more embodiments of systems, computer-readable media, and computer-implemented methods that solve one or more problems by utilizing a single-stage diffusion model for multi-view object and/or scene generation from a single view image of the object or scene. In one or more instances, the disclosed systems utilize a diffusion model to generate three-dimensional (3D) gaussian point clouds representing novel views of an entity depicted in a prompt image from a particular view. For instance, the disclosed systems utilize a diffusion model to transform noisy image pixels corresponding to a particular viewpoint of an entity into 3D Gaussian point clouds that represent the visual entity from an additional viewpoint as reflected by an input camera condition. As part of the camera conditioning, the disclosed systems, in one or more implementations, utilize custom camera pose conditioning coordinates that improve the diffusion model's depth and 3D geometry perception across scene and object data. In addition, in one or more examples, the disclosed systems improve the generalization and scale of the diffusion model to generate a higher range of images (e.g., depicting scenes and/or objects) by utilizing a scene-object mixed training strategy that trains utilizing scene-level training data and object-level training data with separate denoisers of the diffusion model while controlling the distribution of selected viewpoints for the scene-level training data and object-level training data. Moreover, in one or more instances, the disclosed systems train the diffusion model to generate 3D Gaussian point clouds at each timestep to encourage 3D consistency of generated viewpoints.

### BRIEF DESCRIPTION OF THE DRAWINGS

The detailed description is described with reference to the accompanying drawings in which:

FIG. 1 illustrates a schematic diagram of an example environment in which a digital image-to-3D generation system operates in accordance with one or more implementations.

FIG. 2 illustrates an overview of a digital image-to-3D generation system generating a novel view of an entity from a prompt image utilizing a diffusion model in accordance with one or more implementations.

FIG. 3 illustrates an overview of a digital image-to-3D generation system utilizing a diffusion model to generate novel view 3D Gaussian point clouds in accordance with one or more implementations.

FIGS. 4A and 4B illustrate a digital image-to-3D generation system training a diffusion model for multi-view object and/or scene generation in accordance with one or more implementations.

FIG. 5 illustrates a digital image-to-3D generation system utilizing a diffusion model to generate a novel view new image in accordance with one or more implementations.

FIG. 6 illustrates a digital image-to-3D generation system utilizing a diffusion model to generate novel views of scenes and objects in accordance with one or more implementations.

FIGS. 7A-7E and 8 illustrate experimental results of an implementation of a digital image-to-3D generation system in accordance with one or more implementations.

FIG. 9 illustrates a schematic diagram of a digital image-to-3D generation system in accordance with one or more implementations.

FIG. 10 illustrates a flowchart of a series of acts for utilizing a diffusion model to generate 3D Gaussians representing a novel view of a prompt image in accordance with one or more implementations.

FIG. 11 illustrates a flowchart of a series of acts for training a diffusion model to generate 3D Gaussian point clouds in accordance with one or more implementations.

FIG. 12 shows an example of a diffusion model denoising noised data in a latent space in accordance with one or more implementations;

FIG. 13 shows an example of a method for media generation in accordance with one or more implementations;

FIG. 14 shows a denoising process in accordance with one or more implementations;

FIG. 15 shows a flow diagram depicting an algorithm as a step-by-step procedure for training a machine-learning model in accordance with one or more implementations;

FIG. 16 shows a flow diagram for initializing an untrained model and updating parameters of the model in accordance with one or more implementations;

FIG. 17 shows an example of a computing device in accordance with one or more implementations; and

FIG. 18 shows an example of a generative AI digital visual system apparatus (e.g., for interacting with digital image-to-3D generation system 106) in accordance with one or more implementations.

### DETAILED DESCRIPTION

This disclosure describes one or more implementations of a digital image-to-3D generation system that bakes gaussian splatting into a diffusion denoiser for fast and scalable single-stage image-to-3D generation. Specifically, the digital image-to-3D generation system utilizes a diffusion model to generate 3D Gaussian point clouds representing novel viewpoints of 3D objects and/or scenes from images depicting the objects and/or scenes from a particular viewpoint. In particular, in one or more cases, the digital image-to-3D generation system utilizes a single stage diffusion model that diffuses noisy images of a view to generate 3D Gaussian point clouds that represent the view (e.g., a scene or object) from a different (or novel) viewpoint.

In one or more implementations, the digital image-to-3D generation system receives a prompt image representing a visual entity (e.g., an object or scene) from a particular viewpoint. Moreover, in one or more instances, the digital image-to-3D generation system utilizes a noisy version of the prompt image and an input camera condition (e.g., indicating a requested viewpoint) with a diffusion model to denoise the noisy version of the prompt image into 3D Gaussian point clouds that represent the visual entity depicted in the prompt image from an additional viewpoint (e.g., based on the input camera condition). Additionally, in one or more implementations, the digital image-to-3D generation system rasterizes the 3D Gaussian point clouds to generate a new image depicting the visual entity (e.g., the object or scene) from the additional (novel) viewpoint.

Moreover, in one or more instances, the digital image-to-3D generation system utilizes a customized camera pose condition to improve depth and 3D geometry perception while generating novel viewpoints (of 3D objects or scenes) from a prompt image. In particular, the digital image-to-3D generation system customizes a Plücker ray coordinate by utilizing a ray corresponding to a second viewpoint based on a nearest coordinate point on a ray nearest to an origin point of a world coordinate system of the prompt image. Indeed, the customized reference-point Plücker coordinate enables the diffusion model to generate novel views of prompt images depicting objects or scenes with improved perception of depth and 3D geometry.

Additionally, the digital image-to-3D generation system trains a diffusion model to generate 3D Gaussian point clouds representing visual entities from novel viewpoints by generating predicted 3D Gaussian point clouds at each timestep of training instead of generating noise predictions. In addition, in one or more instances, the digital image-to-3D generation system also utilizes a mixed scene-object training objective. For instance, the digital image-to-3D generation system selects viewpoints from scene-level training images and object-level training images using viewpoint angle constraints to encourage convergence of training from the large domain of discrepancies between the scene-level training images and object-level training images. Furthermore, in one or more implementations, the digital image-to-3D generation system utilizes separate denoisers to generate 3D Gaussian point clouds from the scene-level training images and the object-level training images to determine a measure of loss for training of the diffusion model.

As mentioned above, many conventional systems have a number of shortcomings, particularly with regards to accurately, efficiently, and flexibly generating multi-view images. To illustrate, many existing feed-forward image-to-3D methods often utilize two stage approach. In particular, many existing systems adopt a 2D diffusion model to generate blocked multi-view images and second feed the multi-view images into a 3D reconstruction model. However, many of these two stage image-to-3D methods are inaccurate and cannot enforce view consistency. Indeed, oftentimes, such two stage image-to-3D methods often collapse when the prompt view direction changes.

In addition, conventional image-to-3D generation systems are also often inefficient. In particular, some existing systems train a 3D diffusion model with a 2D rendering loss to accomplish image-to-3D outputs. Such existing systems often rely on triplane neural radiance field (NeRF) and are inefficient. For instance, volume rendering of NeRF is time-consuming (e.g., one shot generation at 30 seconds or more) and the triplane resolution is limited.

Furthermore, conventional image-to-3D generation systems are also inflexible. To illustrate, as just mentioned, existing systems that often rely on triplane neural radiance field (NeRF) are resolution limited which prevents scaling to larger scenes. In addition, many conventional systems rely on object-centric datasets and are not able to easily generalize to larger-scale scene-level generation. Accordingly, in many existing systems, the type of prompt images for multi-view generation is limited to specific objects.

The digital image-to-3D generation system provides a number of advantages relative to these conventional systems. For example, the digital image-to-3D generation system improves the accuracy of image-to-3D generation. To illustrate, the digital image-to-3D generation system 106 utilizes a single-stage 3D Gaussian splatting based diffusion model that enforces 3D consistency of the generated contents by predicting multi-view pixel-aligned Gaussian primitives in timesteps (e.g., each or most timesteps) of the diffusion model. In addition, the digital image-to-3D generation system also utilizes a customized reference-point Plücker coordinate that improves the diffusion models perception of depth and 3D geometry across both scene and object data to boost the accuracy of utilizing the diffusion model to generate novel views from prompt images.

Furthermore, unlike many conventional systems that rely on time-consuming NeRF volume rendering, the digital image-to-3D generation system utilizes generated 3D gaussian point clouds from a diffusion model to quickly generate multi-views from an input prompt view. For example, the digital image-to-3D generation system utilizes a diffusion model trained to generate 3D Gaussian point clouds to enable highly parallel rasterization and scalable imaging range. Indeed, in one or more implementations of the digital image-to-3D generation system, the diffusion model achieves a fast inference (e.g., multi-view generation) speed of approximately 6 seconds per asset and easily applies to large scenes.

Moreover, in contrast to conventional systems that are unable to easily scale, the digital image-to-3D generation system utilizes a diffusion model that easily generalizes to a variety of objects and scenes (e.g., including large scenes). For instance, the digital image-to-3D generation system utilizes a scene-object mixed training strategy to learn a general prior of geometry and texture for both scene and object datasets (e.g., large datasets). Moreover, to avoid non-convergence between the scene and object datasets, the digital image-to-3D generation system further utilizes viewpoint selection by controlling the distribution of the selected views, camera condition, Gaussian point clouds, and image depths (e.g., via viewpoint angle constraints) to promote convergence while training utilizing the mixed scene and object training data. Accordingly, the digital image-to-3D generation system utilizes a flexible diffusion model trained to generate a wider variety of novel views from both images depicting objects and/or scenes.

Additionally, as part of the camera conditioning, the disclosed systems, in one or more implementations, utilize custom camera pose conditioning coordinates that improve the diffusion model's depth and 3D geometry perception across scene and object data. In addition, in one or more examples, the disclosed systems improve the generalization and scale of the diffusion model to generate a higher range of images (e.g., depicting scenes and/or objects) by utilizing a scene-object mixed training strategy that trains utilizing scene-level training data and object-level training data with separate denoisers of the diffusion model while controlling the distribution of selected viewpoints for the scene-level training data and object-level training data.

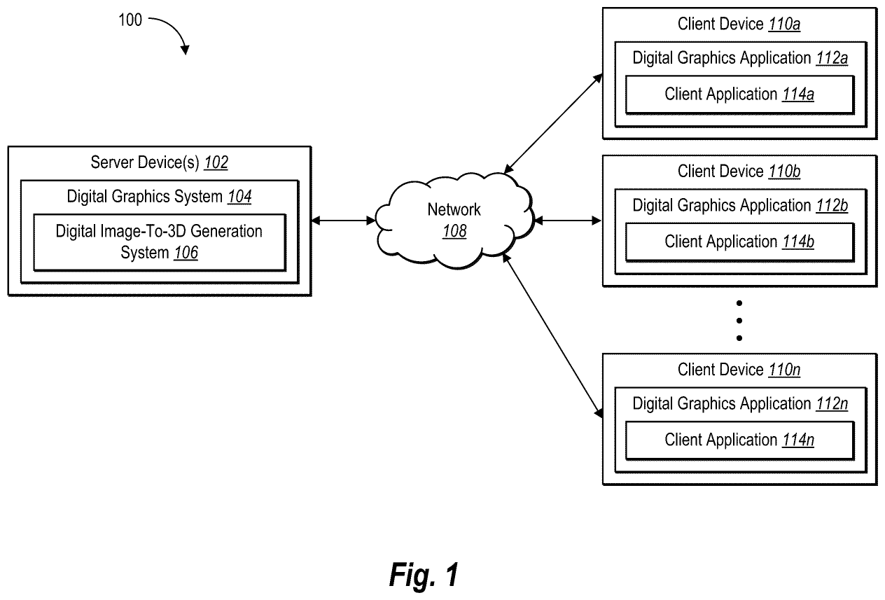

Turning now to the figures, FIG. 1 illustrates a schematic diagram of one or more implementations of a system 100 (or environment) in which a digital image-to-3D generation system operates in accordance with one or more implementations. As illustrated in FIG. 1, the system 100 includes a server device(s) 102, a network 108, and client devices 110a-110n. As further illustrated in FIG. 1, the server device(s) 102 and the client devices 110a-110n communicate via the network 108.

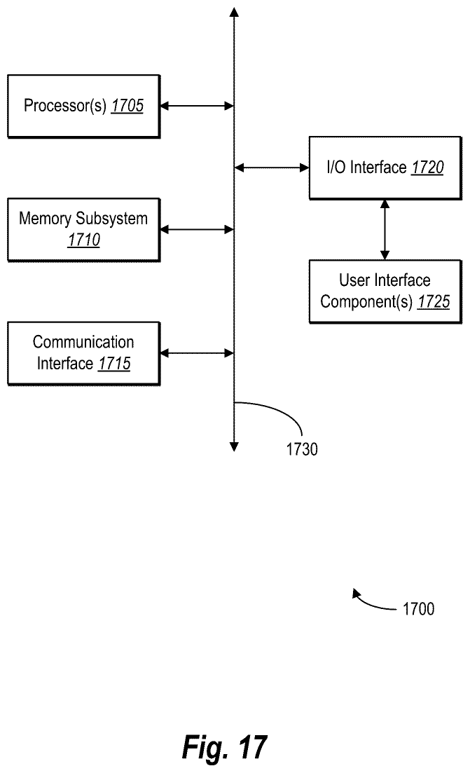

In one or more implementations, the server device(s) 102 includes, but is not limited to, a computing (or computer) device (as explained below with reference to FIG. 17). As shown in FIG. 1, the server device(s) 102 include a digital graphics system 104 which further includes the digital image-to-3D generation system 106. In one or more implementations, the digital graphics system 104 is able to generate, train, store, deploy, and/or utilize various machine learning models for various machine learning applications, such as, but not limited to, image tasks, 3D visual tasks, and/or video tasks.

Moreover, as explained below, the digital image-to-3D generation system 106, in one or more embodiments, utilizes a diffusion model to generate 3D Gaussian point clouds representing novel viewpoints of 3D objects and/or scenes from images depicting the objects and/or scenes from a particular viewpoint. Indeed, in one or more instances, the digital image-to-3D generation system 106 utilizes a diffusion model to generate three-dimensional (3D) gaussian point clouds that rasterize into new images that represent novel views of an entity depicted in a prompt image. Furthermore, in some implementations, the digital image-to-3D generation system 106 also trains a diffusion model to transform noisy image pixels corresponding to a particular viewpoint of an entity into 3D Gaussian point clouds that represent the visual entity from an additional viewpoint as reflected by an input camera condition through a scene-object mixed training.

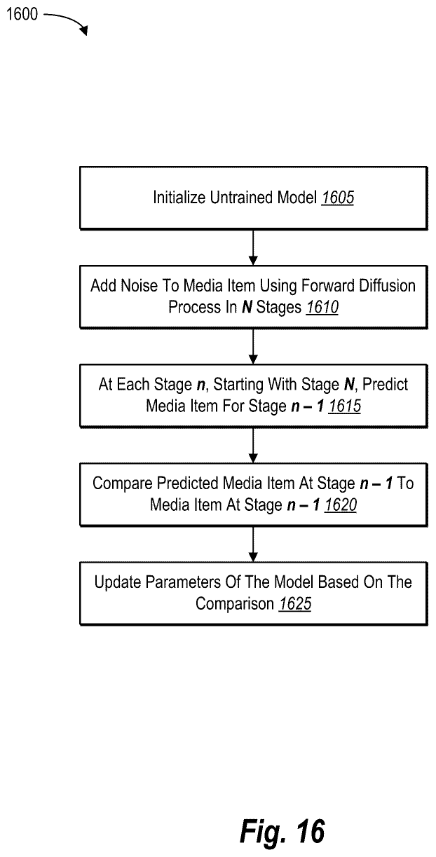

Furthermore, as shown in FIG. 1, the system 100 includes the client devices 110a-110n. In one or more implementations, the client devices 110a-110n includes, but is not limited to, mobile devices (e.g., smartphone, tablet), laptops, desktops, or any other type of computing devices, including those explained below with reference to FIG. 16. In certain implementations, although not shown in FIG. 1, the client devices 110a-110n are operated by a user to perform a variety of functions (e.g., via the digital graphics applications 112a-112n). For example, the client devices 110a-110n perform functions such as, but not limited to, providing (or capturing) prompt images for the diffusion model to generate 3D Gaussian point clouds representing novel viewpoints of 3D objects and/or scenes from the prompt image on the client devices 110a-110n.

To access the functionalities of the digital image-to-3D generation system 106 (as described above), in one or more implementations, users interact with the digital graphics applications 112a-112n on the client devices 110a-110n. For example, the digital graphics applications 112a-112n includes one or more software applications installed on the client devices 110a-110n (e.g., to utilize diffusion models in accordance with one or more implementations herein). In some cases, the digital graphics applications 112a-112n are hosted on the server device(s) 102. In addition, when hosted on the server device(s) 102, the digital graphics applications 112a-112n are accessed by the client devices 110a-110n through a web browser and/or another online interfacing platform and/or tool. In such implementations, the client device(s) 110a-110n provide a digital image to the digital image-to-3D generation system 106 on the server device(s) 102, which then generate novel views utilizing diffusion models with three-dimensional gaussian point clouds. Once the novel views are generated, the server device(s) 102 return the novel views to the client device(s) 110a-110n.

To provide an example implementation, in some embodiments, the digital graphics system 104 on the server device(s) 102 supports the digital graphics system 104 on the client device(s) 110a-110n. For example, the digital graphics system 104 on the server device(s) 102 trains the digital image-to-3D generation system 106 and its machine learning models. The client device(s) 110a-110n obtains (e.g., downloads) the trained digital image-to-3D generation system 106 from the server device(s) 102. Once downloaded, the digital image-to-3D generation system 106 on the client device(s) 110a-110n is able to generate novel views from a single digital image independent from the server device(s) 102.

Although FIG. 1 illustrates the digital image-to-3D generation system 106 being implemented by a particular component and/or device within the system 100 (e.g., the server device(s) 102), in some implementations, the digital image-to-3D generation system 106 is implemented, in whole or in part, by other computing devices and/or components in the system 100. For example, in some implementations, the digital image-to-3D generation system 106 is implemented on the client devices 110a-110n within the digital graphics applications 112a-112n (e.g., via client applications 114a-114n). Indeed, in one or more implementations, the description of (and acts performed by) the digital image-to-3D generation system 106 are implemented (or performed by) the client applications 114a-114n when the client devices 110a-110n implement the digital image-to-3D generation system 106. More specifically, in some instances, the client devices 110a-110n (via an implementation of the digital image-to-3D generation system 106 on the client applications 114a-114n) utilize a diffusion model to generate 3D Gaussian point clouds representing novel viewpoints of 3D objects and/or scenes from images depicting the objects and/or scenes from a particular viewpoint.

Additionally, as shown in FIG. 1, the system 100 includes the network 108. As mentioned above, in some instances, the network 108 enables communication between components of the system 100. In certain implementations, the network 108 includes a suitable network and may communicate using any communication platforms and technologies suitable for transporting data and/or communication signals, examples of which are described with reference to FIG. 16. Furthermore, although FIG. 1 illustrates the server device(s) 102 and the client devices 110a-110n communicating via the network 108, in certain implementations, the various components of the system 100 communicate and/or interact via other methods (e.g., the server device(s) 102 and the client devices 110a-110n communicating directly).

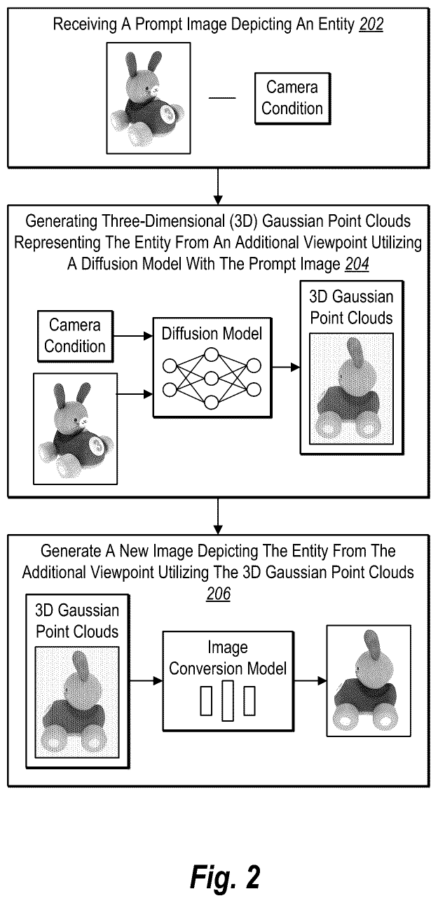

As mentioned above, in one or more implementations, the digital image-to-3D generation system 106 utilizes a diffusion model to generate 3D gaussian point clouds representing novel views of an entity depicted in a prompt image from a particular view. For example, FIG. 2 illustrates an overview of the digital image-to-3D generation system 106 generating a novel view of an entity from a prompt image depicting the entity utilizing a diffusion model. In particular, FIG. 2 illustrates the digital image-to-3D generation system 106 utilizing a diffusion model to generate 3D gaussian point clouds representing novel viewpoints of an entity (e.g., an object or scene) depicted in a prompt image. For instance, FIG. 2 illustrates the digital image-to-3D generation system 106 receiving a prompt image depicting an entity, generating 3D Gaussian point clouds representing the entity from an additional viewpoint utilizing a diffusion model to diffuse the prompt image, and generating a new image depicting the entity from the additional viewpoint utilizing the 3D Gaussian point clouds.

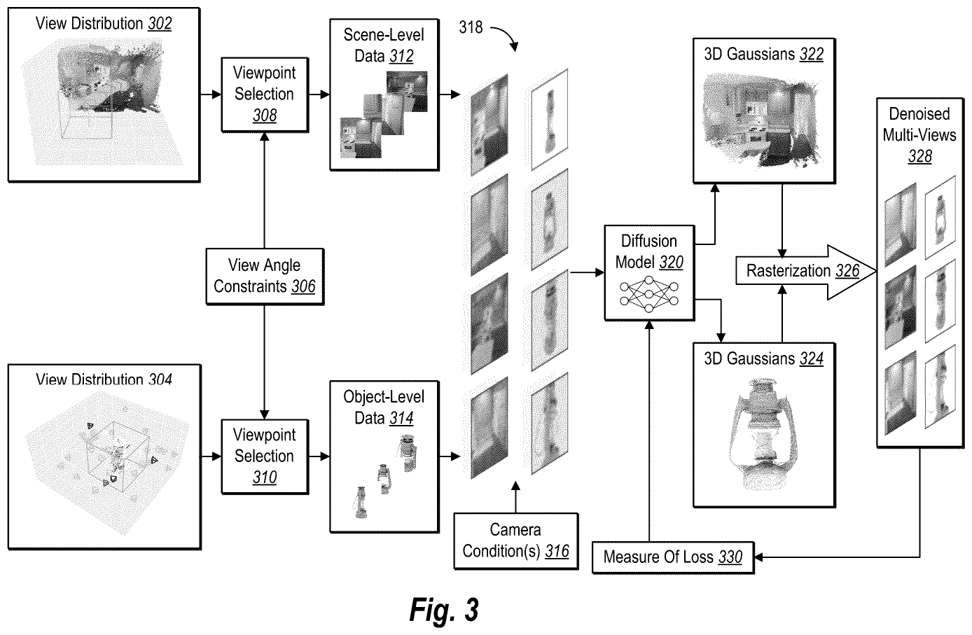

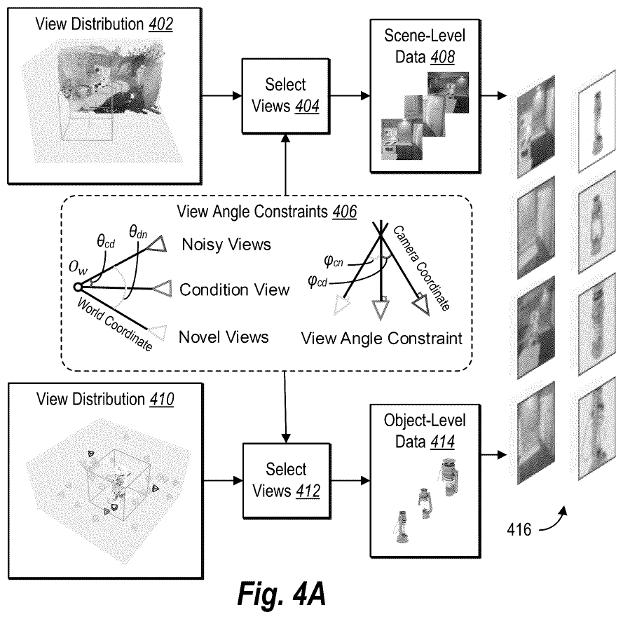

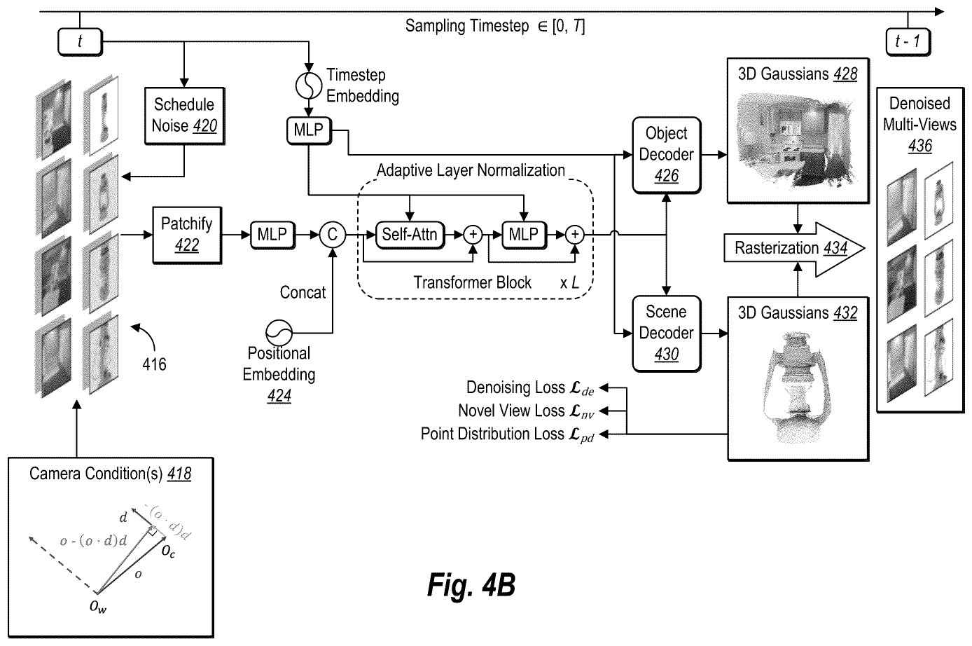

As shown in an act 202 of FIG. 2, the digital image-to-3D generation system 106 receives a prompt image depicting an entity. For instance, the digital image-to-3D generation system 106 receives an image that depicts an object or a scene from a particular viewpoint. In addition, in one or more implementations, the digital image-to-3D generation system 106 also receives an input camera condition indicating a prompt viewpoint to generate from the prompt image. Indeed, in one or more instances, the digital image-to-3D generation system 106 identifies prompt images and camera conditions as described in greater detail below (e.g., with reference to FIGS. 3 and 4A).

In one or more embodiments, an image (sometimes referred to as a digital image) includes a digital symbol, picture, icon, and/or other visual illustration depicting one or more subjects (or entities). For instance, an image includes a digital file having a visual illustration and/or depiction of an entity (e.g., an object or scene). Indeed, in some implementations, an image includes, but is not limited to, a digital file with the following extensions: JPEG, TIFF, BMP, PNG, RAW, or PDF. In some instances, an image includes a frame from a digital video file having an extension such as, but not limited to the following extensions: MP4, MOV, WMV, or AVI.

Furthermore, in one or more instances, a camera condition includes parameters that define how an image is captured. In particular, in one or more implementations, a camera condition includes camera properties (e.g., focal length, principal point). Moreover, in one or more embodiments, a camera condition includes a position and/or orientation of a camera. Additionally, in one or more instances, a camera condition includes properties, such as, but not limited to, a camera pose, a depth of field, and/or field of view. In some instances, the camera condition indicates a viewpoint of an image. In one or more instances, a camera condition includes a customized reference-point Plücker coordinate (in accordance with one or more implementations herein). Additionally, in one or more implementations, a viewpoint (or view) includes a specific position and orientation from which an image is captured relative to a depicted object and/or scene.

As shown in FIG. 2, the digital image-to-3D generation system 106 generates 3D Gaussian point clouds representing the visual entity from an additional viewpoint utilizing a diffusion model with the prompt image in act 204. For example, the digital image-to-3D generation system 106 utilizes the prompt image depicting an entity from a particular viewpoint and a camera condition with a diffusion model to transform noise into 3D Gaussian point clouds representing the entity from a novel viewpoint (e.g., a different viewpoint than the prompt image conditioned on the camera condition). In one or more instances, the digital image-to-3D generation system 106 trains the diffusion model utilizing a scene-object mixed training approach to generate 3D Gaussian point clouds representing novel views of a variety of scenes and objects. Indeed, the digital image-to-3D generation system 106 training and utilizing a diffusion model to generate 3D Gaussian point clouds representing novel views is described in greater detail below (e.g., with reference to FIGS. 3, 4A, and 4B).

Additionally, in one or more instances, a 3D Gaussian point cloud (or 3D Gaussian) includes a 3D representation in which a point includes spatial uncertainty and appearance to enable continuous and smooth reconstructions via Gaussian splatting. For instance, a 3D Gaussian point cloud includes properties, such as, but not limited to, position (e.g., a center point in 3D space), a covariance matrix, opacity, color, scale, and rotation. In some cases, a set of 3D Gaussian point clouds create a Gaussian radiance field that represents a visual representation capable of rendering into an image (e.g., via rasterization).

Furthermore, in one or more embodiments, a diffusion model (or sometimes referred to as diffusion neural network) includes a generative model (e.g., a machine learning model) that iteratively denoises a data to generate an output representation. In particular, in some cases, a diffusion model includes a generative model that denoises a noise representation (e.g., Gaussian noise, random noise) to generate a digital image. In one or more instances, a diffusion model includes a generative model that generates (or denoises) a noise representation into 3D Gaussian point clouds in accordance with one or more implementations herein.

Furthermore, in one or more instances, a neural network includes a machine learning model that is trainable and/or tunable based on inputs to generate content or approximate unknown functions. For example, a neural network includes a model of interconnected artificial neurons (e.g., organized in layers) that communicate and learn to approximate complex functions and generate outputs (e.g., generated digital images) based on a plurality of inputs provided to the neural network. In some cases, a neural network refers to an algorithm (or set of algorithms) that implements deep learning techniques to model high-level abstractions in data.

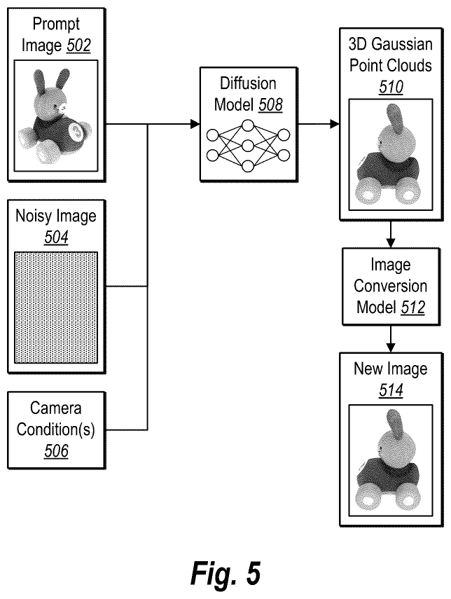

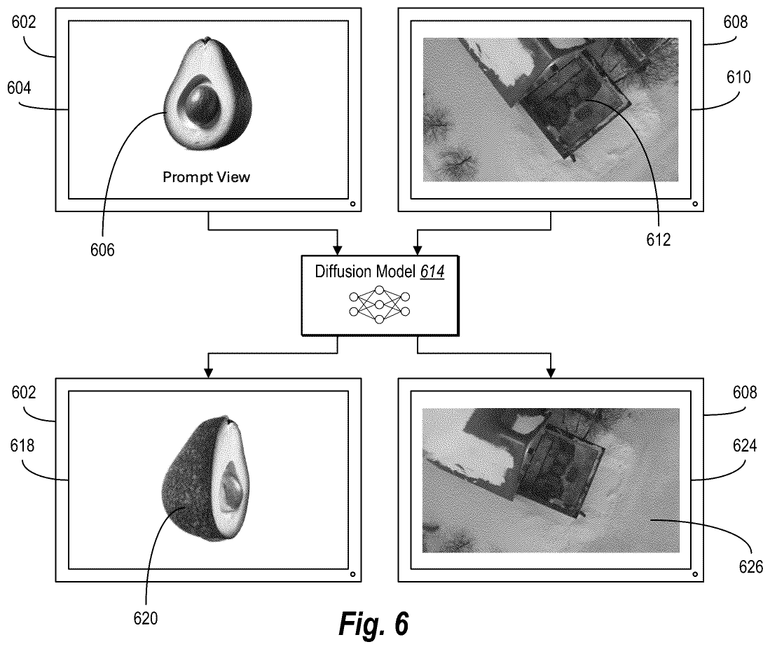

Furthermore, as shown in an act 206 of FIG. 2, the digital image-to-3D generation system 106 generates a new image depicting the entity from the additional viewpoint utilizing the 3D Gaussian point clouds. For example, as shown in FIG. 2, the digital image-to-3D generation system 106 utilizes the 3D Gaussian point clouds with an image conversion model to generate an image depicting the viewpoint represented by the 3D Gaussian point clouds. For instance, the digital image-to-3D generation system 106 rasterizes the 3D Gaussian point clouds to generate the new image of the novel viewpoint. Indeed, in one or more instances, the digital image-to-3D generation system 106 generates a new image depicting a novel viewpoint from 3D Gaussian point clouds as described in greater detail below (e.g., with reference to FIGS. 5 and 6).

Furthermore, FIG. 3 illustrates an overview of the digital image-to-3D generation system 106 training and utilizing a diffusion model to generate 3D Gaussian point clouds representing a novel viewpoint(s) of a prompt image. In particular, FIG. 3 illustrates an overview of the digital image-to-3D generation system 106 utilizing scene-object mixed training to learn a diffusion model that generalizes both novel 3D object and scene viewpoint generation.

For example, as shown in FIG. 3, the digital image-to-3D generation system 106 identifies a view distribution 302 of scene-level images. Moreover, as shown in an act 308 of FIG. 3, the digital image-to-3D generation system 106 utilizes view angle constraints 306 to select viewpoints of scene-level data 312 (e.g., training images depicting scenes from particular viewpoints) for training data 318. In addition, as shown in FIG. 3, the digital image-to-3D generation system 106 identifies a view distribution 304 of object-level images. Furthermore, as shown in an act 310 of FIG. 3, the digital image-to-3D generation system 106 utilizes the view angle constraints 306 to select viewpoints of object-level data 314 (e.g., training images depicting objects from particular viewpoints) for the training data 318.

Furthermore, as shown in FIG. 3, the digital image-to-3D generation system 106 utilizes the scene-level data 312 with camera condition(s) 316 to provide a prompt image from a first viewpoint and a noisy image from a second viewpoint (of a scene) to the diffusion model 320. Indeed, as further illustrated in FIG. 3, the digital image-to-3D generation system 106 utilizes the diffusion model 320 (e.g., through a particular denoiser for the scene-level data) to generate 3D Gaussian point clouds 322 representing a scene from the prompt image (of the scene-level data 312) from the second viewpoint.

In addition, as shown in act 326 of FIG. 3, the digital image-to-3D generation system 106 rasterizes the 3D Gaussian point clouds 322 to generate the denoised multi-views 328 (e.g., new images) representing the scene from the scene-level data 312 from the second viewpoint. Moreover, as shown in FIG. 3, the digital image-to-3D generation system 106 generates a measure of loss 330 by comparing a new image from the denoised multi-views 328 to a ground truth image corresponding to the noisy image from the second viewpoint from the scene-level data 312. In one or more embodiments, the digital image-to-3D generation system 106 modifies parameters of the diffusion model 320 utilizing the measure of loss 330.

Moreover, as shown in FIG. 3, the digital image-to-3D generation system 106 also utilizes the object-level data 314 with camera condition(s) 316 to provide a prompt image from a first viewpoint and a noisy image from a second viewpoint (of an object) with a corresponding viewpoint condition to the diffusion model 320. As further illustrated in FIG. 3, the digital image-to-3D generation system 106 utilizes the diffusion model 320 (e.g., through a particular denoiser for the object-level data) to generate 3D Gaussian point clouds 324 representing an object from the prompt image (of the object-level data 314) from the second viewpoint (e.g., based on the viewpoint condition).

As further shown in act 326 of FIG. 3, the digital image-to-3D generation system 106 rasterizes the 3D Gaussian point clouds 324 to generate the denoised multi-views 328 (e.g., new images) representing the object from the object-level data 314 from the second viewpoint. Moreover, as shown in FIG. 3, the digital image-to-3D generation system 106 generates a measure of loss 330 by comparing a new image from the denoised multi-views 328 to a ground truth image corresponding to the noisy image from the second viewpoint from the object-level data 314. In one or more embodiments, the digital image-to-3D generation system 106 modifies parameters of the diffusion model 320 utilizing the measure of loss 330.

As mentioned above, in one or more implementations, the digital image-to-3D generation system 106 utilizes a scene-object mixed training to train a diffusion model utilizing scene-level training data and object-level training data with separate denoisers of the diffusion model while controlling the distribution of selected viewpoints for the scene-level training data and object-level training data. In particular, FIGS. 4A and 4B illustrate the digital image-to-3D generation system 106 training the diffusion model as a single-stage diffusion model for multi-view object and/or scene generation from a single view image of the object or scene (via scene-object mixed training). Indeed, FIGS. 4A and 4B illustrate the digital image-to-3D generation system 106 training and utilizing the diffusion model to generate 3D Gaussian point clouds representing novel views of an entity depicted in a prompt image from a particular view.

As shown in FIG. 4A, the digital image-to-3D generation system 106 identifies training data for a diffusion model. In particular, as shown in an act 404 of FIG. 4A, the digital image-to-3D generation system 106 selects scene-level data 408 (e.g., scene training images) by selecting viewpoints from a view distribution 402 (of scene views) using view angle constraints 406. As also shown in an act 412 of FIG. 4A, the digital image-to-3D generation system 106 selects object-level data 414 (e.g., object training images) by selecting viewpoints from a view distribution 410 (of 3D object views) using the view angle constraints 406. Although FIG. 4A illustrates the digital image-to-3D generation system 106 utilizing a particular view distribution for a particular scene and object, the digital image-to-3D generation system 106, in one or more instances, utilizes view distributions for multiple scenes and/or objects.

Indeed, as shown in FIG. 4A, the digital image-to-3D generation system 106 utilizes view angle constraints for camera position between noisy views and novel views (to ensure overlaps with condition views). Also, as shown in FIG. 4A, the digital image-to-3D generation system 106 utilizes view angle constraints for camera orientation between the noisy views and novel views (to ensure overlaps with condition views). As shown in FIG. 4A, the digital image-to-3D generation system 106, for each view distribution (e.g., various object view distributions and various scene view distributions) identifies a set of noisy views, condition views, and novel views that satisfy the view angle constraints as the scene-level data 408 and/or the object-level data 414 to generate the training data 416.

Furthermore, as shown in the transition from FIG. 4A to FIG. 4B, the digital image-to-3D generation system 106 utilizes the training data 416 at a timestep t with camera condition(s) 418 as input into a diffusion model. Indeed, as shown in FIG. 4B, the digital image-to-3D generation system 106 generates a customized camera pose conditioning coordinates as the camera pose conditions to utilize with the prompt image prompts from the training data 416. Moreover, as shown in act 420 of FIG. 4B, the digital image-to-3D generation system 106 introduces noise in the noisy views from the scene-level and object-level views (in the training data 416). As further shown in an act 422 of FIG. 4B, the digital image-to-3D generation system 106, patchifies the prompt images from the training data 416. Moreover, as shown in FIG. 4B, the digital image-to-3D generation system 106 utilizes a concatenation of a positional embedding 424 with the patchified prompt images with a transformer block of the diffusion model to generate a feature representation (e.g., token) for the prompt images from the training data 416.

Additionally, as shown in FIG. 4B, the digital image-to-3D generation system 106 utilizes a separate decoder (e.g., an object decoder 426 and a scene decoder 430 as MLPs) to decode the feature representations of the prompt images from the training data 416 into 3D Gaussian point clouds. For instance, the digital image-to-3D generation system 106 generates 3D Gaussians 428 from feature representations created using the camera condition(s) 418 and object-level data 414 (within the training data 416) using the object decoder 426 (e.g., an MLP). Additionally, the digital image-to-3D generation system 106 generates 3D Gaussians 432 from feature representations created using the camera condition(s) 418 and object-level data 414 (within the training data 416) using the object decoder 426 (e.g., an MLP). In one or more instances, as shown in FIG. 4B, the digital image-to-3D generation system 106 utilizes the diffusion model to generate 3D Gaussian point clouds from the prompt images at each timestep T.

In addition, as shown in an act 434 of FIG. 4B, the digital image-to-3D generation system 106 rasterizes the 3D Gaussians 428 and 3D Gaussians 432 to generate the denoised multi-views 436. Indeed, in one or more instances, the digital image-to-3D generation system 106 compares the denoised multi-views 436 to ground truth novel views (e.g., from the scene-level data 408 and the object-level data 414) to determine a measure of loss. In particular, as shown in FIG. 4B, the digital image-to-3D generation system 106 determines a denoising loss [symbol] , a novel view loss [symbol] , and a point distribution loss [symbol] (as described in greater detail below). Furthermore, in one or more instances, the digital image-to-3D generation system 106 utilizes the denoising loss [symbol] , a novel view loss [symbol] , and a point distribution loss [symbol] to modify parameters of the diffusion model with a training objective to generate 3D Gaussian point clouds that represent accurate novel views of scenes and objects depicted in the input training prompt images.

For example, the digital image-to-3D generation system 106 utilizes a diffusion model to recover (clean) 3D Gaussian point clouds (instead of predicting noise). Indeed, in one or more embodiments, the digital image-to-3D generation system 106 utilizes a denoiser of a diffusion model to directly predict pixel-aligned 3D Gaussians and utilize supervised raining on (clean) 2D multi-view renderings from the predicted pixel-aligned 3D Gaussian. In reference to FIGS. 4A and 4B, input to the diffusion model during the training phase include a clean condition view x_{con}∈ [symbol] and N noisy views

$${𝒳}_{t} = \{ {x}_{t}^{( 1 )} , {x}_{t}^{( 2 )} , … , {x}_{t}^{( N )} \}$$

concatenated with viewpoint conditions v_{con}∈ [symbol] and [symbol] ={v⁽¹⁾, v⁽²⁾, v^{(N)}}. In addition, in one or more implementations, the digital image-to-3D generation system 106 utilizes clean counterparts of the noisy views as

$${𝒳}_{0} = \{ {x}_{0}^{( 1 )} , {x}_{0}^{( 2 )} , ... , {x}_{0}^{( N )} \} .$$

Moreover, in one or more instances, the digital image-to-3D generation system 106 adds noise to each view in a forward diffusion process in accordance with the following function:

$${x}_{t}^{( i )} = {\overline{α}}_{t} {x}_{0}^{( i )} + \sqrt{1 - {\overline{α}}_{t}} {ε}_{t}^{( i )} \qquad ( 1 )$$

In the above mentioned function (1), in one or more implementations, the digital image-to-3D generation system 106 utilizes a

$${ε}_{t}^{( i )} ∼ 𝒩 ( 0 , I )$$

and i=1, 2, . . . , N. Furthermore, in one or more embodiments, at each timestep t, the denoiser θ predicts the 3D Gaussians [symbol] to enforce view consistency. Moreover, in one or more implementations, the digital image-to-3D generation system 106 utilizes pixel-aligned 3D Gaussians as the output.

Indeed, in one or more cases, the digital image-to-3D generation system 106 generates the predicted 3D Gaussians [symbol] in accordance with the following function:

$${𝒢}_{θ} ( {𝒳}_{t} \vert {x}_{con} , {v}_{con} , t , 𝒱 ) = \{ {G}_{t}^{( k )} ( {μ}_{t}^{( k )} , {\sum }_{t}^{( k )} , {α}_{t}^{( k )} , {c}_{t}^{( k )} ) \} \qquad ( 2 )$$

In the above mentioned function (2), in one or more implementations, the digital image-to-3D generation system 106 utilizes a number of per-pixel Gaussian

$${G}_{t}^{( k )}$$

as 1≤k≤N_{g} and N_{g}=(N+1)HW where H and W are the height and width of the image. Moreover, in one or more instances, the digital image-to-3D generation system 106 utilizes a per-pixel Gaussian

$${G}_{t}^{( k )}$$

that includes a center position

$${μ}_{t}^{( k )} ∈ {ℝ}^{3} ,$$

a covariance

$${\sum }_{t}^{( k )} ∈ {ℝ}^{3 \times 3}$$

controlling the Gaussian shape, an opacity

$${α}_{t}^{( k )} ∈ ℝ$$

to characterize a transmittance of the Gaussian, and an RGB color

$${c}_{t}^{( k )} ∈ {ℝ}^{3} .$$

In addition, in one or more instances, the digital image-to-3D generation system 106 utilizes

$${μ}_{t}^{( k )} = {o}^{( k )} + {u}_{t}^{( k )} {d}^{( k )}$$

in which o^{(k)} and d^{(k)} are the origin and direction of the k-th pixel aligned ray.

In one or more instances, the digital image-to-3D generation system 106 parameterizes the distance

$${u}_{t}^{( k )}$$

in accordance with the following function:

$${u}_{t}^{( k )} = {w}_{t}^{( k )} {u}_{n e a r} + ( 1 - {w}_{t}^{( k )} ) {u}_{f a r} \qquad ( 3 )$$

In the above mentioned function (3), in one or more instances, the digital image-to-3D generation system 106 utilizes uₙₑₐᵣ and u_{far} as the nearest and farthest distances. Moreover, in one or more instances, the digital image-to-3D generation system 106 utilizes

$${w}_{t}^{( k )} ∈ ℝ$$

as a weight to control

$${u}_{t}^{( k )} .$$

Furthermore, in one or more implementations, the digital image-to-3D generation system 106 parameterizes

$${\sum }_{t}^{( k )}$$

by a rotating matrix

$${R}_{t}^{( k )}$$

ana a scaling matrix

$${S}_{t}^{( k )} .$$

Additionally, in one or more instances, the digital image-to-3D generation system 106 directly extracts

$${w}_{t}^{( k )} , {R}_{t}^{( k )} , {S}_{t}^{( k )} , {α}_{t}^{( k )} , and {c}_{t}^{( k )}$$

from merged per-pixel Gaussian maps by splitting channels.

Moreover, as shown in FIG. 4B, the digital image-to-3D generation system 106 concatenates the prompt images with the viewpoint conditions. Moreover, as shown in FIG. 4B, in some cases, the digital image-to-3D generation system 106 patchifies, linearly projects and concatenates the prompt images concatenated with the viewpoint conditions with a positional embedding to derive the input tokens of the Transformer backbone (e.g., a Transformer including L number of transformer blocks). In one or more instances, each block includes a multi-head self-attention (MSA), an MLP, and two layer normalization (LN). Moreover, in one or more instances, the digital image-to-3D generation system 106 utilizes the diffusion model to feed the output tokens into a Gaussian decoder to be linearly projected and then unpatchified into per-pixel Gaussian maps [symbol] ={Ĥ_{con}, Ĥ⁽¹⁾, . . . , Ĥ^{(N)}, where Ĥ_{con} and Ĥ⁽ⁱ⁾∈ [symbol] . Furthermore, in one or more instances, the digital image-to-3D generation system 106 merges N+1 of the Gaussian maps [symbol] into the Gaussian point clouds [symbol] (as shown in function (2) above). Additionally, in one or more cases, the digital image-to-3D generation system 106 utilizes the timestep condition to control the Transformer block and Gaussian decoder through the adaptive layer normalization mechanism.

Furthermore, in one or more instances, the digital image-to-3D generation system 106 utilizes 2D renderings of the predicted Gaussians [symbol] to train (e.g., supervise) the predicted Gaussians [symbol] of the diffusion model. For example, in some cases, the digital image-to-3D generation system 106 utilizes a multi-view diffusion model. For instance, the digital image-to-3D generation system 106 utilizes a diffusion model for x₀-prediction instead of ϵ-prediction (e.g., noise prediction) to derive clean and complete 3D Gaussians. In particular, in one or more embodiments, the digital image-to-3D generation system 106 generates the denoised multi-view images

$${\hat{𝒳}}_{( 0 , t )} = \{ {\hat{x}}_{( 0 , t )}^{( 1 )} , {\hat{x}}_{( 0 , t )}^{( 2 )} , … , {\hat{x}}_{( 0 , t )}^{( N )} \}$$

utilizing a (differentiable) rasterization function Fᵣ in accordance with the following function:

$${\hat{x}}_{( 0 , t )}^{( i )} = {F}_{r} ( {M}_{ext}^{( i )} , {M}_{int}^{( i )} , {𝒢}_{θ} ( {𝒳}_{t} \vert {x}_{con} , {v}_{con} , t , 𝒱 ) )$$

In the above mentioned function (4), in one or more instances, the digital image-to-3D generation system 106 utilizes an i that is 1≤i≤N. Additionally, in one or more cases, the digital image-to-3D generation system 106 utilizes

$${M}_{ext}^{( i )} and {M}_{int}^{( i )}$$

to represent an extrinsic matrix and intrinsic matrix of the viewpoint cⁱ.

Moreover, in one or more instances, for each Gaussian point cloud

$${G}_{t}^{( k )}$$

at viewpoint cⁱ, the digital image-to-3D generation system 106 projects (via the rasterization) the Gaussians point cloud's 3D covariance

$${\sum }_{t}^{( k )}$$

from the world coordinate system to

$${\sum }_{t}^{′ ( k , i )} ∈ {ℝ}^{3 \times 3}$$

in the camera coordinate system in accordance to the following function:

$${\sum }_{t}^{′ ( k , i )} = {J}_{t}^{( i )} {W}_{t}^{( i )} {\sum }_{t}^{( k )} {W}_{t}^{{( i )}^{T}} {J}_{t}^{{( i )}^{T}}$$

In the above mentioned function (5), in one or more implementations, the digital image-to-3D generation system 106 utilizes a

$${J}_{t}^{( i )} ∈ {ℝ}^{3 \times 3}$$

as the Jacobian matrix of the affine approximation of the projective transformation. In addition, in one or more embodiments, the digital image-to-3D generation system 106 utilizes

$${W}_{t}^{( i )}$$

as the viewing transformation.

Indeed, in some cases, the digital image-to-3D generation system 106 divides a 2D projection into non-overlapping tiles. Moreover, in some cases, the digital image-to-3D generation system 106 assigns 3D Gaussians to the tiles covered by their 2D projections. Indeed, in some implementations, the digital image-to-3D generation system 106, for each tile, sorts the assigned 3D Gaussians according to the view space depth. Additionally, in some instances, the digital image-to-3D generation system 106 derives an RGB value at pixel (m,n) by blending [symbol] ordered points overlapping the pixel in accordance with the following function (6):

$${\hat{x}}_{( 0 , t )}^{( i )} ( m , n ) = {\sum }_{j ∈ 𝒩} {c}_{t}^{( j )} {σ}_{t}^{( j )} {\prod }_{l = 1}^{j - 1} ( 1 - {σ}_{t}^{( l )} ) \qquad ( 6 )$$

In the above mentioned function (6), in one or more implementations, the digital image-to-3D generation system 106 utilizes an

$${σ}_{t}^{( l )} = {α}_{t}^{( l )} P ( {z}_{t}^{( l )} \vert {μ}_{t}^{( l )} , {\sum }_{t}^{( l )} )$$

and an l-th intersection 3D point

$${z}_{t}^{( l )} .$$

Moreover, in one or more instances, digital image-to-3D generation system 106 generates the

$$P ( {z}_{t}^{( l )} \vert {μ}_{t}^{( l )} , {\sum }_{t}^{( l )} )$$

as the possibility of the corresponding 3D gaussian distribution at

$${z}_{t}^{( l )} .$$

Furthermore, in one or more instances, the digital image-to-3D generation system 106 utilizes a weighted sum, controlled by a parameter λ, of [symbol] loss and a perceptual loss [symbol] (e.g., a difference in feature space) between the multi-view predicted images [symbol] and ground truth [symbol] as the denoising loss [symbol] to supervise the 3D Gaussians [symbol] in accordance with the following function:

$${ℒ}_{de} = {ℒ}_{2} ( {\hat{𝒳}}_{( 0 , t )} , {𝒳}_{0} ) + λ \cdot {ℒ}_{VGG} ( {\hat{𝒳}}_{( 0 , t )} , {𝒳}_{0} ) \qquad ( 7 )$$

Furthermore, in one or more implementations, the digital image-to-3D generation system 106 utilizes the generated 3D Gaussian point clouds [symbol] at a timestep t=0 (as described in function (2)) to render novel view images (e.g., via rasterization).

Moreover, in some implementations (e.g., during inference testing), the digital image-to-3D generation system 106 randomly samples noise from a standard normal distribution at timestep T and gradually denoises the noise step by step. Indeed, in some cases, the predicted images [symbol] at each timestep t are fed into the next timestep t−1 to replace the image [symbol] for sampling [symbol] at each noisy view in accordance with the following function:

$${x}_{t - 1}^{( i )} = {\overline{α}}_{t - 1} {\hat{x}}_{( 0 , t )}^{( i )} + \sqrt{1 - {\overline{α}}_{t - 1}} {ε}_{t - 1}^{( i )} \qquad ( 8 )$$

Additionally, in some implementations, the digital image-to-3D generation system 106 skips one or more intermediate timesteps of the diffusion model while training the diffusion model to generate 3D Gaussian point clouds. For example, in some cases, the digital image-to-3D generation system 106 utilizes a stochastic differential equation to facilitate the sampling speed by skipping intermediate timesteps of the diffusion model.

Furthermore, as mentioned above (and shown in FIGS. 4A and 4B), in one or more implementations, the digital image-to-3D generation system 106 utilizes a scene-object mixed training approach that improves the scale of 3D diffusion models to apply to both objects and large scenes (while also controlling for non-convergence between the scene and object training data). Indeed, in order to control for non-convergence between the scene and object training data, in one or more embodiments, the digital image-to-3D generation system 106 selects viewpoints from the scene and object data utilizing viewpoint angle constraints. In particular, in one or more instances, the digital image-to-3D generation system 106 utilizes viewpoint angle constraints on camera positions and/or camera orientations to ensure noisy views and novel views have overlaps with the condition view.

For example, in some cases, the digital image-to-3D generation system 106 utilizes a viewpoint angle constraint on the angle between the viewpoint positions. In particular, in one or more instances, after normalization, the digital image-to-3D generation system 106 utilizes an angle between viewpoint positions that measures the distance of viewpoints. For instance, the digital image-to-3D generation system 106 controls an angle

$${θ}_{cd}^{( i )}$$

between the i-th noisy view position and the condition view position, and the angle

$${θ}_{dn}^{( i , j )}$$

between the i-th noisy view position and the j-th novel view position in accordance with the following function:

$${θ}_{cd}^{( i )} \leq {θ}_{1} , {θ}_{dn}^{( i , j )} \leq {θ}_{2} \qquad ( 9 )$$

In the above mentioned function (9), in some cases, the digital image-to-3D generation system 106 utilizes hyperparameters θ₁ and θ₂, utilizes an i that is 1≤i≤N, and utilizes a j that is 1≤j≤M. In some instances, the digital image-to-3D generation system 106 reads the position vector from the translation of camera-to-world (c2w) matrix of the viewpoint.

Furthermore, in some implementations, the digital image-to-3D generation system 106 utilizes a viewpoint angle constraint on the angle between viewpoint orientations (e.g., to control an overlap of different viewpoints). In particular, in one or more instance, the digital image-to-3D generation system 106 utilizes forward direction vectors of the condition view, the i-th noisy view, and the j-th novel view as

$${\vec{z}}_{con} , {\vec{z}}_{noise}^{( i )} , and {\vec{z}}_{nv}^{( j )}$$

to determine a viewpoint angle constraint between viewpoint orientations in accordance with the following function:

$$\frac{{\vec{z}}_{con} \cdot {\vec{z}}_{noise}^{( i )}}{\vert {\vec{z}}_{con} \vert \cdot \vert {\vec{z}}_{noise}^{( i )} \vert} \geq cos ( {φ}_{1} ) , \frac{{\vec{z}}_{con} \cdot {\vec{z}}_{nv}^{( j )}}{\vert {\vec{z}}_{con} \vert \cdot \vert {\vec{z}}_{nv}^{( j )} \vert} \geq cos ( {φ}_{2} ) \qquad ( 10 )$$

In the above mentioned function (10), in some cases, the digital image-to-3D generation system 106 utilizes hyperparameters φ₁ and φ₂. Moreover, in some instances, in reference to function (10), the digital image-to-3D generation system 106 utilizes vector z from the camera-to-world (c2w) matrix of the viewpoint.

Additionally, in one or more instances, the digital image-to-3D generation system 106 utilizes camera conditions that adopt a pixel-aligned ray embedding (e.g., Plücker coordinates, concatenated with the image as input. Indeed, in one or more instances, the digital image-to-3D generation system 106 utilizes pixel-aligned ray embeddings parameterized as r=(o×d, d), where o and d are the position and direction of the ray landing on the pixel (e.g., a bounding ray). In particular, in one or more instances, the digital image-to-3D generation system 106 utilizes o×d to represent the rotational effect of o relative to d.

Moreover, as mentioned above, to improve the perception of relative depth and geometry, in one or more implementations, the digital image-to-3D generation system 106 utilizes a customized camera pose condition. Indeed, as shown in FIG. 4B, the digital image-to-3D generation system 106, in some instances, utilizes a customized reference-point Plücker coordinate by utilizing a point on a ray closest to the origin of the world coordinate system as the reference point to replace the moment vector in accordance with the following function:

$$r = ( o - ( o \cdot d ) d , d ) \qquad ( 11 )$$

Indeed, by utilizing the customized reference-point Plücker coordinate as described in function (11), the digital image-to-3D generation system 106, in one or more implementations, satisfies the translation invariance assumption of the fourth-dimensional (4D) light field. In addition, in one or more instances, the digital image-to-3D generation system 106 utilizes the customized reference-point Plücker coordinate to provide more information about the ray position and the relative depth in comparison to the moment vector to benefit the diffusion model in capturing the 3D geometry of scenes and objects. In some instances, the digital image-to-3D generation system 106 utilizes skip connections in the diffusion model to flow the customized reference-point Plücker coordinate through one or more Transformer blocks and one or more Gaussian decoders to guide generating of the 3D Gaussian point clouds.

Moreover, as also shown in FIG. 4B, in one or more instances, the digital image-to-3D generation system 106 utilizes dual scene and object decoders to decode Gaussian primitives for objects and scenes in mixed training to handle the varying depth range across object- and scene-level datasets. In some instances, the digital image-to-3D generation system 106 configures the Gaussian decoders individually for the object-level data and the scene-level data. For example, the digital image-to-3D generation system 106 utilizes separate nearest and farthest distances ([uₙₑₐᵣ, u_{far}]) for an object-level Gaussian decoder and a scene-level Gaussian decoder. In addition, in one or more instances, the digital image-to-3D generation system 106, during training, controls the object-level Gaussian decoder and a scene-level Gaussian decoder utilizing a timestep embedding. Additionally, in one or more implementations, the digital image-to-3D generation system 106 also finetunes a single Gaussian decoder instead of separate object-level Gaussian decoders and a scene-level Gaussian decoders. In one or more implementations, the object decoder 426 and the scene decoder 430 comprise MLPs.

Furthermore, in one or more instances, the digital image-to-3D generation system 106 utilizes a denoising loss (as described in function (7)) for the scene-level and object-level data by determining an [symbol] loss and a perceptual loss on novel views (using hyperparameters λ). In addition, the digital image-to-3D generation system 106 utilizes a novel view loss [symbol] Moreover, to encourage the distribution of 3D Gaussian point clouds of object-centric generation with more concentration, in one or more instances, the digital image-to-3D generation system 106 utilizes a point distribution loss [symbol] in accordance with the following function:

$${ℒ}_{pd} = {𝔼}_{k} [ {l}_{t}^{( k )} - ( \frac{{l}_{t}^{( k )} - {𝔼}_{k} [ {l}_{t}^{( k )} ]}{\sqrt{Var ( {l}_{t}^{( k )} )}} ) {σ}_{0} + {𝔼}_{k} [ \vert {o}^{( k )} \vert ] ] \qquad ( 12 )$$

In the above mentioned function (12), in one or more instances, the digital image-to-3D generation system 106 utilizes a mean value [symbol] ,

$${l}_{t}^{( k )} = \vert {u}_{t}^{( k )} {d}^{k} \vert ,$$

Var denotes the variance, and σ₀ is the target standard deviation (e.g., a standard deviation that is configurable via an administrator device).

In some implementations, the digital image-to-3D generation system 106 determines an overall training objective [symbol] (for the scene-object mixed training) in accordance with the following function:

$$ℒ = ( {ℒ}_{de} + {ℒ}_{nv} ) \cdot {1}_{iter > {iter}_{0}} + {ℒ}_{pd} \cdot {1}_{iter > {iter}_{0}} \cdot {1}_{object} \qquad ( 13 )$$

In one or more implementations, in reference to the above mentioned function (13), the digital image-to-3D generation system 106 utilizes 1_{iter>iter}_{₀}, 1_{iter<iter}_{₀}, and 1_{object} as conditional indicator functions which equal 1 if the current training iteration (iter) is greater than the threshold iteration (e.g., iter₀).

Furthermore, in one or more embodiments, the digital image-to-3D generation system 106 utilizes weights to finetune the diffusion model via the scene-level training data and object-level training data. For instance, the digital image-to-3D generation system 106 provides separate weights for losses belonging to scene-level views and object-level views. For instance, the digital image-to-3D generation system 106 utilizes a first weight for losses of a scene-level predicted view and a second weight for losses of an object-level predicted view.

As mentioned above, in one or more implementations, the digital image-to-3D generation system 106 utilizes a diffusion transformer model with a streamlined architecture. FIG. 4B illustrates the digital image-to-3D generation system 106 utilizing transformer block(s) of a diffusion transformer model to generate a Gaussian primitives in accordance with one or more embodiments. In one or more embodiments, a transformer block refers to an individual block in a single stream transformer. Specifically, the digital image-to-3D generation system 106 utilizes a transformer block of a single stream transformer to remove noise and generate a Gaussian primitive.

For instance, for a single stream transformer with multiple transformer blocks, the digital image-to-3D generation system 106 utilizes a first transformer block to remove some noise from a noised token to generate an intermediate denoised token. In one or more embodiments, the digital image-to-3D generation system 106 utilizes transformer blocks to remove at least some noise from the noised tokens. For instance, the digital image-to-3D generation system 106 generates an intermediate denoised token by using a first transformer block. Specifically, an intermediate denoised token refers to a partially noised token. Specifically, once the digital image-to-3D generation system 106 utilizes the single stream transformer to remove all the noise from the noised tokens, the digital image-to-3D generation system 106 generates the Gaussian primitives.

FIG. 4B shows that the transformer block includes a self-attention layer and a multi-layer perceptron. In one or more embodiments, the self-attention layer refers to layer that captures the importance of different tokens (e.g., patches) in a sequence relative to each other. Specifically, the digital image-to-3D generation system 106 utilizes the self-attention layer to capture relationships and dependencies between tokens (e.g., for both short-range and long-range dependencies).

In other words, the digital image-to-3D generation system 106 utilizes the self-attention layer to determine how much attention a token should give to another token. To illustrate, the digital image-to-3D generation system 106 utilizes the self-attention layer to generate three vectors for each token, 1) a query vector (e.g., represents the token seeking information from other tokens), 2) a key vector (e.g., represents the token providing information to other tokens), and 3) a value vector (e.g., represents the actual content of the token).

In one or more embodiments, the digital image-to-3D generation system 106 utilizes the self-attention layer to generate a self-attention layer output that represents an updated set of intermediate noised tokens (e.g., or denoised tokens) that incorporate information from other noised tokens (e.g., the updated set of noised tokens represents relationships between tokens). In one or more embodiments, the digital image-to-3D generation system 106 further combines the self-attention layer output with the input to the transformer block corresponding to the self-attention layer to generate the combined self-attention layer output.

In one or more embodiments, a digital image-to-3D generation system 106 utilizes the multi-layer perceptron. For example, the multi-layer perceptron refers to an artificial neural network with multiple layers of neurons that are fully connected. Specifically, the multi-layer perceptron includes an input layer, where the input data is fed into the network, hidden layers (e.g., intermediate layers between an input and output layer, where the hidden layers receive input from all the neurons in the previous layer), and an output layer that generates the multi-layer perceptron output (e.g., by combining the combined self-attention layer output with the output from the multi-layer perceptron).

Although one or more embodiments describe utilizing a particular set of components and/or losses, the digital image-to-3D generation system 106, in one or more cases, utilizes various combinations of components and losses. For instance, the digital image-to-3D generation system 106 utilizes varying combinations of the above described measures of losses to train the diffusion model (e.g., a perceptual loss and a point distribution loss). In addition, in one or more instances, the digital image-to-3D generation system 106 utilizes various numbers of MLPs and/or transformer blocks as part of the diffusion model.

As further shown in FIG. 5, the digital image-to-3D generation system 106 utilizes a diffusion model (trained in accordance with one or more implementations herein) to generate new images of novel viewpoints from a prompt digital image. For instance, as shown in FIG. 5, the digital image-to-3D generation system 106 identifies a prompt image 502 (as a prompt image) and camera condition(s) 506 (e.g., requesting a novel viewpoint of the digital image based on the camera condition(s). As shown in FIG. 5, the digital image-to-3D generation system 106 utilizes a diffusion model 508 with the prompt image 502 and the camera condition(s) 506 to diffuse a noisy image 504 to generate 3D Gaussian point clouds 510 representing the entity depicted in the input digital image from a novel viewpoint (conditioned on the camera condition(s) 506).

Furthermore, as shown in FIG. 5, the digital image-to-3D generation system 106 utilizes an image conversion model 512 to render a new digital image 514 from the 3D Gaussian point clouds 510 to depict the entity from the novel viewpoint. For example, as described above, the digital image-to-3D generation system 106 utilizes, as the image conversion model, a rasterization approach to generate an output digital image from the 3D Gaussian point clouds 510 generated by the diffusion model 508.

In one or more instances, the digital image-to-3D generation system 106 utilizes rasterization (as the image conversion model 512) to render views of scenes and/or objects as images from 3D Gaussian point clouds. In one or more embodiments, the digital image-to-3D generation system 106 utilizes various rasterization approaches to render images from the 3D Gaussian point clouds. For example, the digital image-to-3D generation system 106 utilizes rasterization approaches, such as, but not limited to, tile-based rasterization, forward rasterization, and/or hierarchical rasterization.

Moreover, in one or more instances, the digital image-to-3D generation system 106 utilizes the diffusion model (in accordance with one or more implementations herein) to generate multiple novel views of an entity depicted in an input digital image using varying input camera condition(s). Indeed, in one or more instances, the digital image-to-3D generation system 106 utilizes the diffusion model to generate 3D Gaussian point clouds depicting the input digital image from a variety of viewpoints using different camera conditions. Furthermore, in one or more instances, the digital image-to-3D generation system 106 rasterizes the 3D Gaussian point clouds depicting the input digital image from a variety of viewpoints to generate the multi-views of the entity depicted in the input digital image.

In addition, as described above, in one or more implementations, the digital image-to-3D generation system 106 utilizes a diffusion model to generate multi-view new images for a variety of scene and object views. Indeed, in one or more instances, the digital image-to-3D generation system 106 utilizes scene-object mixed training to enable the diffusion model to generate novel views from prompt images that depict objects and/or scenes (in accordance with one or more implementations herein).

For instance, as shown in FIG. 6, the digital image-to-3D generation system 106 receives, within a graphical user interface 604 of a client device 602, a prompt view 606 from an image depicting a 3D object. Furthermore, as shown in FIG. 6, the digital image-to-3D generation system 106 utilizes the prompt view 606 with a diffusion model 614 (trained in accordance with one or more implementations herein) to generate 3D Gaussian point clouds that are rendered as a new image depicting the object from a novel view. For instance, as shown in FIG. 6, the digital image-to-3D generation system 106 generates and provides, for display within a graphical user interface 618 of the client device 602, a new novel view 620 utilizing the diffusion model 614 to depict the 3D object from a different viewpoint (e.g., utilizing rasterization of 3D Gaussian point clouds in accordance with one or more implementations herein).

Furthermore, as shown in FIG. 6, the digital image-to-3D generation system 106 receives, within a graphical user interface 610 of a client device 608, a prompt view 612 from an image depicting a scene. Additionally, as shown in FIG. 6, the digital image-to-3D generation system 106 utilizes the input prompt view 612 with the diffusion model 614 (trained in accordance with one or more implementations herein) to generate 3D Gaussian point clouds that are rendered as a new image depicting the scene from a novel view. For example, as shown in FIG. 6, the digital image-to-3D generation system 106 generates and provides, for display within a graphical user interface 624 of the client device 608, a new novel view 626 utilizing the diffusion model 614 to depict the scene from a different viewpoint (e.g., utilizing rasterization of 3D Gaussian point clouds in accordance with one or more implementations herein).

In some implementations, the digital image-to-3D generation system 106 utilizes text-to-image data to generate novel views. For example, the digital image-to-3D generation system 106 chains a diffusion model (in accordance with one or more implementations herein) with a text-to-image generative model to generate novel views. In particular, in one or more implementations, the digital image-to-3D generation system 106 receives a text prompt describing a requested image in different views (e.g., moving through an art gallery, footage of a city). In response, in one or more instances, the digital image-to-3D generation system 106 utilizes a text-to-image generative model to generate an image and the diffusion model (in accordance with one or more implementations herein) to generate novel views of the image (to achieve the requested views).

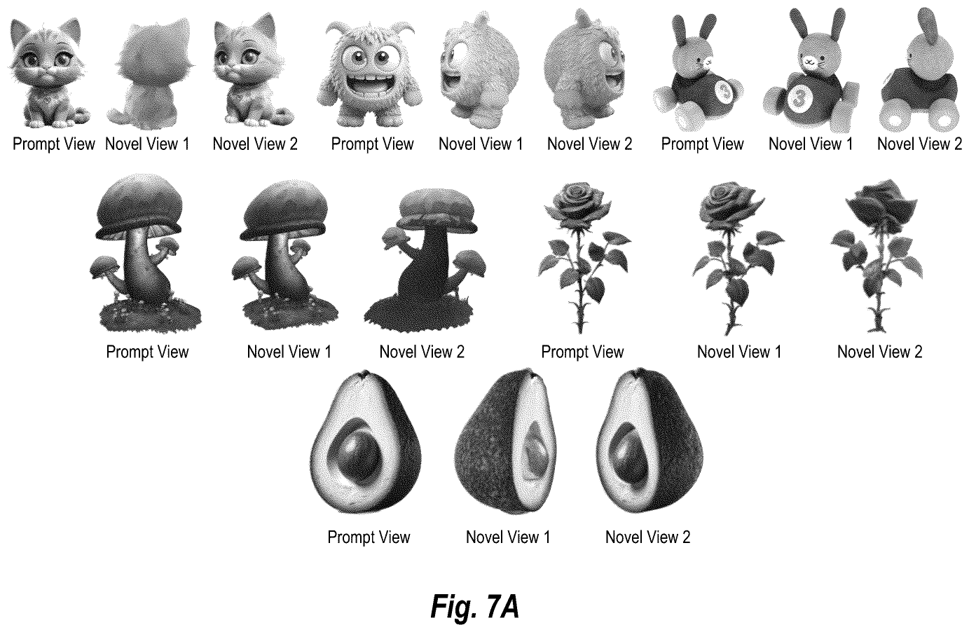

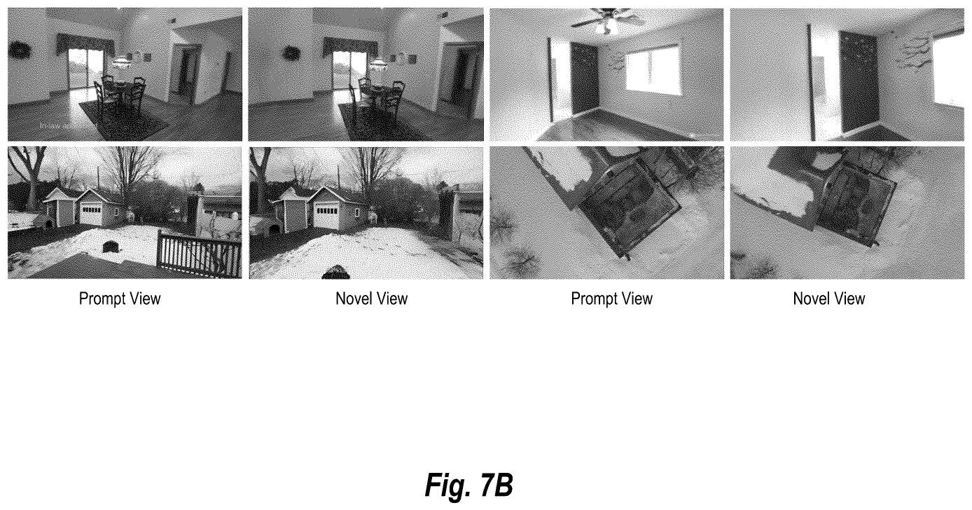

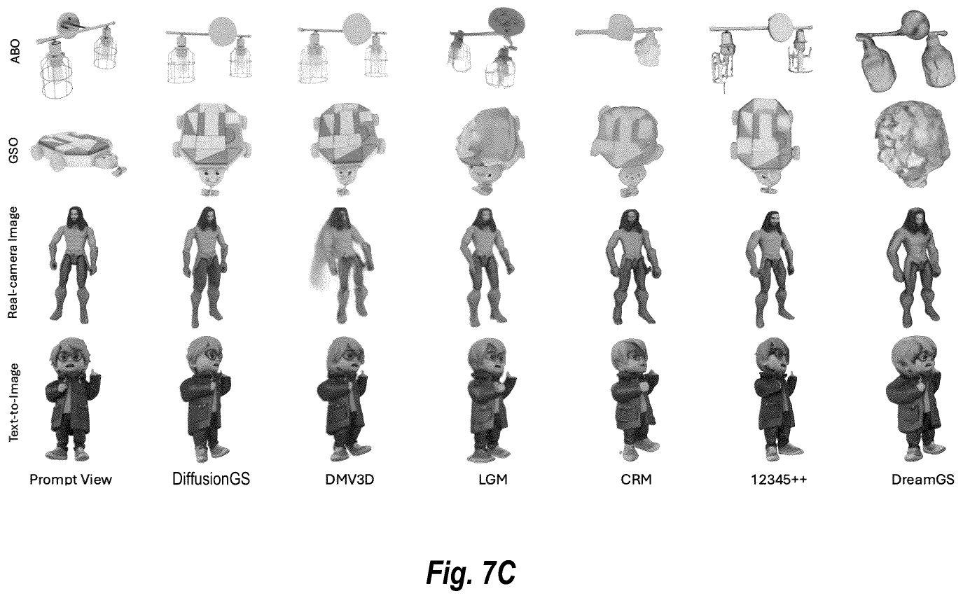

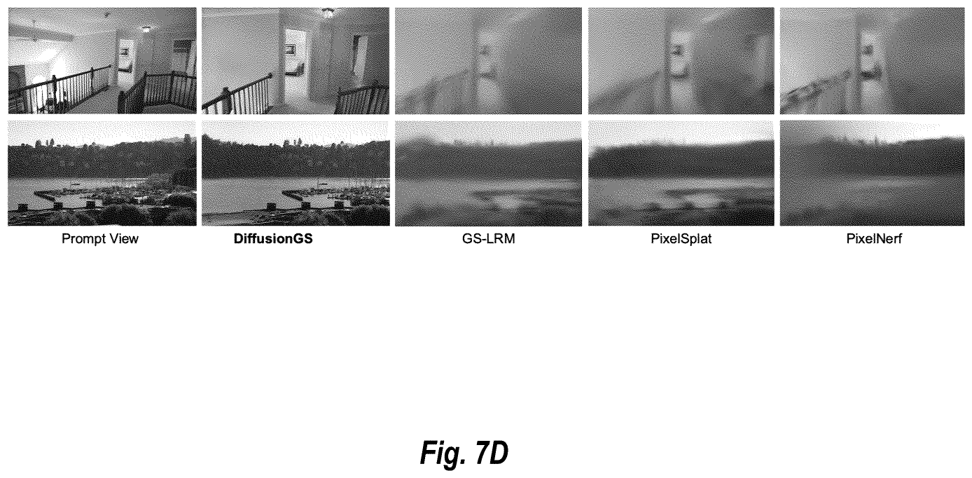

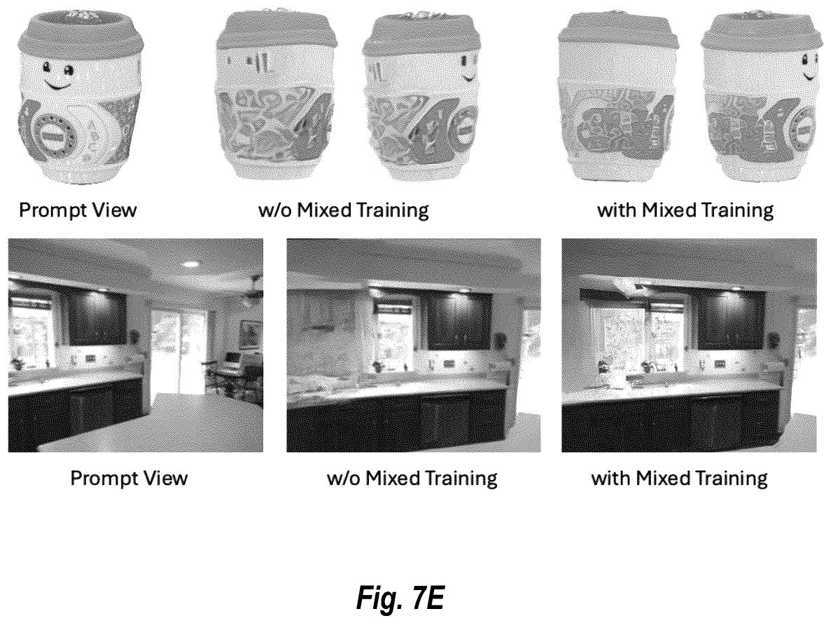

Indeed, in one or more instances, the digital image-to-3D generation system 106 generates novel views of a variety of objects and/or scenes utilizing 3D Gaussian point clouds generated by a diffusion model from a prompt image in accordance with one or more implementations herein. To illustrate, FIG. 7A illustrates an implementation of the digital image-to-3D generation system generating novel views (e.g., novel views 1 and novel views 2) from prompt views of various images depicting 3D objects (identified from wild images and text-to-image prompted images created by diffusion models). As shown in FIG. 7A, the implementation of the digital image-to-3D generation system robustly handles cases with furry appearances, shadows, flat illustration, complex geometry, and/or specularity. In addition, FIG. 7B illustrates an implementation of the digital image-to-3D generation system generating novel views (e.g., with rotation and occlusion) from prompt views of images depicting scenes.

Experimenters utilized an implementation of the digital image-to-3D generation system to compare against baseline models. In particular, the Experimenters gathered image data from ABO (as described in Collins et al., Abo: Dataset and Benchmarks for Real-World 3D Object Understanding, CVPR (2022)), GSO (as described in Downs et al., Google Scanned Objects: A High Quality Dataset of 3D Scanned Household Items, ICRA (2022), real-camera image, and text-to-image prompted by FLUX AI image generator. In addition, the experimenters utilized baseline methods including a one-stage 3D diffusion DMV3D (as described in Xu et al., DMV3D: Denoising Multi-View Diffusion Using 3D Large Reconstruction Model, ICLR (2024)), LGM (as described in Tang et al., LGM: Large Multi-View Gaussian Model for High-Resolution 3D Content Creation, ECCV (2024)), CRM (as described in Wang et al., CRM: Single Image to 3D Textured Mesh With Convolutional Reconstruction Model, ECCV (2024)), 12345++ (as described in Liu et al., One-2-3-45++: Fast Single Image To 3D Objects With Consistent Multi-View Generation and 3D Diffusion, CVPR, 2024)), and DreamGS (as described in Tang et al., DreamGaussian: Generative Gaussian Splatting For Efficient 3D Content Creation, ArXiv:2309.16653 (2023). Indeed, the experimenters utilized the baseline methods with the gathered image data to generate novel views from the gathered image data. In addition, the experimenters utilized an implementation of the digital image-to-3D generation system (as described herein) to also generate novel views from the gathered image data. For example, FIG. 7C illustrates the visual comparisons of object-level generations from the gathered image data from the baseline methods and an implementation of the digital image-to-3D generation system (i.e., DiffusionGS). As shown in FIG. 7C, DiffusionGS generates more fine-grained details with accurate geometry from prompt views of any direction.

The experimenters also conducted a study to determine running time to generate novel views. Indeed, Table 1 below demonstrates the running times of the different baseline methods and DiffusionGS. As shown in Table 1, DiffusionGS resulted in a low inference time.

TABLE 1

| Method | DreamGaussia | DMV3D | CRM | 12345+ | DiffusionG |
|---|---|---|---|---|---|
| Running | 120 | 31.4 | 10 | 60 | 5.8 |
| Time (s) | | | | | |

In addition, the experimenters also trained baseline scene reconstruction models including GS-LRM (as described in Zhang, et al., GS-LRM: Large Reconstruction Model For 3D Gaussian Splatting, ECCV (2024)), pixelSplat (as described in Charatan et al., Pixel Splat: 3D Gaussian Splats From Image Pairs For Scalable Generalizable 3D Reconstructions, CVPR (2024)), and pixelNeRF (as described in Yu et al., PixelNeRF: Neural Radiance Fields From One Or Few Images, CVPR (2021)). The experimenters utilized images from RealEstate10K dataset (as described in Zhou et al., Stereo Magnification: Learning View Synthesis Using Multiplane Images, SIGGRAPH (2018)) and DL3DV-10K (as described in Ling et al., DL3DV-10K: A Large-Scale Scene Dataset For Deep Learning-Based 3D Vision, CVPR (2024)). In particular, the baseline scene reconstruction models utilizing single input views and a same number of supervised views as DiffusionGS (e.g., an implementation of the digital image-to-3D generation system). For example, FIG. 7D illustrates visual comparisons of single-view scene generation between DiffusionGS and the baseline scene reconstruction models. As shown in FIG. 7D, the implementation of the digital image-to-3D generation system (DiffusionGS) robustly generated both indoor and outdoor scenes with occlusion and rotation with more accuracy than the outputs of the baseline scene reconstruction models.

Furthermore, the experimenters conducted ablation studies of various implementations of the digital image-to-3D generation system. For instance, the experimenters utilized implementations of the digital image-to-3D generation system with scene-object mixed training and without scene-object mixed training. For instance, FIG. 7E illustrates example images generated by the implementations of the digital image-to-3D generation system with and without scene-object mixed training. As shown in both object-level views and scene-level views (in FIG. 7E), the utilization of scene-object mixed training (in accordance with one or more implementations herein) improves textures and artifact reduction in the object level views and improves the capture of 3D geometry and the generation of more structural content (e.g., windows, stove) in the scene level views.

Indeed, Table 5 illustrates quantitative results of the effect of each component of an implementation of the digital image-to-3D generation system (e.g., DiffusionGS, DiffusionGS with point distribution loss [symbol] , with mixed scene-object training, and with utilization of customized reference-point Plücker coordinates (RPPC)). In addition, Table 5 shows quantitative results of using a baseline (e.g., a denoiser without timestep control). As shown in Table 2, the various components of the digital image-to-3D generation system (as described herein) improve novel view generation.

TABLE 2

| Method | Baseline | + | + [symbol] | + Mixed | + RPPC |
|---|---|---|---|---|---|
| PSNR 1 | 17.63 | 20.57 | 20.94 | 21.73 | 22.07 |
| SSIM 1 | 0.7928 | 0.8120 | 0.8423 | 0.8515 | 0.8545 |
| LPIPS V | 0.2452 | 0.1417 | 0.1218 | 0.1196 | 0.1115 |
| FID V | 118.31 | 47.86 | 28.41 | 17.79 | 11.52 |

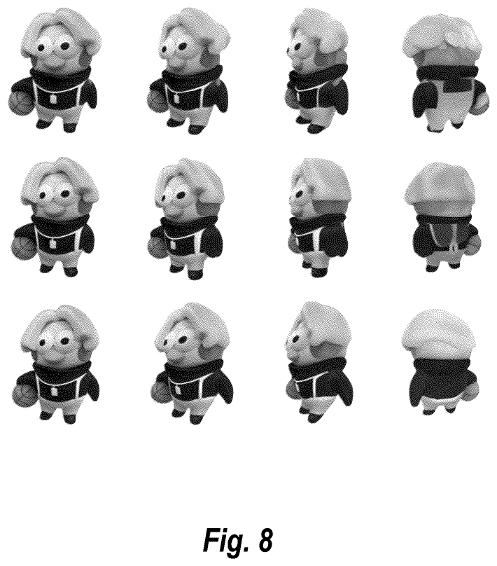

Furthermore, the experimenters evaluated the generation diversity of DiffusionGS (e.g., an implementation of the digital image-to-3D generation system) by changing the random seed with the same front prompt view image. As shown in FIG. 8, DiffusionGS is capable of generating different shapes and textures for 3D assets when utilizing the same prompt view image with different random seeds.

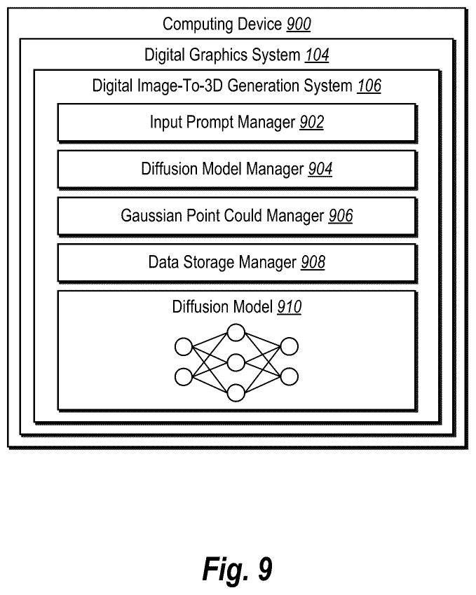

Turning now to FIG. 9, additional detail will be provided regarding components and capabilities of one or more embodiments of the digital image-to-3D generation system. In particular, FIG. 9 illustrates an example digital image-to-3D generation system 106 executed by a computing device 900 (e.g., the server device(s) 102 and/or the client devices 110a-110n). As shown by the embodiment of FIG. 9, the computing device 900 includes or hosts the digital graphics system 104 and the digital image-to-3D generation system 106. Furthermore, as shown in FIG. 9, the digital graphics system 104 includes an input prompt manager 902, a diffusion model manager 904, a Gaussian point cloud manager 906, and data storage manager 908.

As just mentioned, and as illustrated in the embodiment of FIG. 9, the digital image-to-3D generation system 106 includes the input prompt manager 902. For example, the input prompt manager 902 identifies object-level and scene-level data as described above (e.g., in relation to FIGS. 3 and 4A). Furthermore, in some instances, the input prompt manager 902 selects viewpoints for the object-level and scene-level data utilizing viewpoint angle constraints as described above (e.g., in relation to FIGS. 3 and 4A).

Moreover, as shown in FIG. 9, the digital image-to-3D generation system 106 includes the diffusion model manager 904. In some cases, the diffusion model manager 904 generates, from prompt image prompts, 3D Gaussian point clouds representing novel views of entities depicted within the prompt image prompts as described above (e.g., in relation to FIGS. 3-6). In particular, in one or more embodiments, the diffusion model manager 904 trains utilizing a mixed scene-object level data training approach as described above (e.g., in relation to FIGS. 3, 4A, and 4B).

Furthermore, as shown in FIG. 9, the digital image-to-3D generation system 106 includes the Gaussian point cloud manager 906. In some embodiments, the Gaussian point cloud manager 906 generates 3D Gaussians representing multi-views of objects and/or scenes depicted within prompt images as described above (e.g., in relation to FIGS. 3-6). In certain instances, the Gaussian point cloud manager 906 utilizes rasterization to generate output multi-view images from 3D Gaussians as described above (e.g., in relation to FIGS. 3-6).

As further shown in FIG. 9, the digital image-to-3D generation system 106 includes the data storage manager 908. In some embodiments, the data storage manager 908 maintains data to perform one or more functions of the digital image-to-3D generation system 106. For example, the data storage manager 908 includes diffusion models, diffusion model parameters, training data (object-level and scene-level data), 3D Gaussians, and/or digital images.

Each of the components 902-908 of the computing device 900 (e.g., the computing device 900 implementing the digital image-to-3D generation system 106), as shown in FIG. 9, may be in communication with one another using any suitable technology. The components 902-908 of the computing device 900 can comprise software, hardware, or both. For example, the components 902-908 can comprise one or more instructions stored on a computer-readable storage medium and executable by processor of one or more computing devices. When executed by the one or more processors, the computer-executable instructions of the digital image-to-3D generation system 106 (e.g., via the computing device 900) can cause a client device and/or server device to perform the methods described herein. Alternatively, the components 902-908 and their corresponding elements can comprise hardware, such as a special purpose processing device to perform a certain function or group of functions. Additionally, the components 902-908 can comprise a combination of computer-executable instructions and hardware.

Furthermore, the components 902-908 of the digital image-to-3D generation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-908 may be implemented as a stand-alone application, such as a desktop or mobile application. Furthermore, the components 902-908 may be implemented as one or more web-based applications hosted on a remote server. The components 902-908 may also be implemented in a suite of mobile device applications or “apps.” To illustrate, the components 902-908 may be implemented in an application, including but not limited to, ADOBE PHOTOSHOP, ADOBE PREMIERE, ADOBE LIGHTROOM, ADOBE ILLUSTRATOR, or ADOBE SUBSTANCE. “ADOBE,” “ADOBE PHOTOSHOP,” “ADOBE PREMIERE,” “ADOBE LIGHTROOM,” “ADOBE ILLUSTRATOR,” or “ADOBE SUBSTANCE” are either registered trademarks or trademarks of Adobe Inc. in the United States and/or other countries.

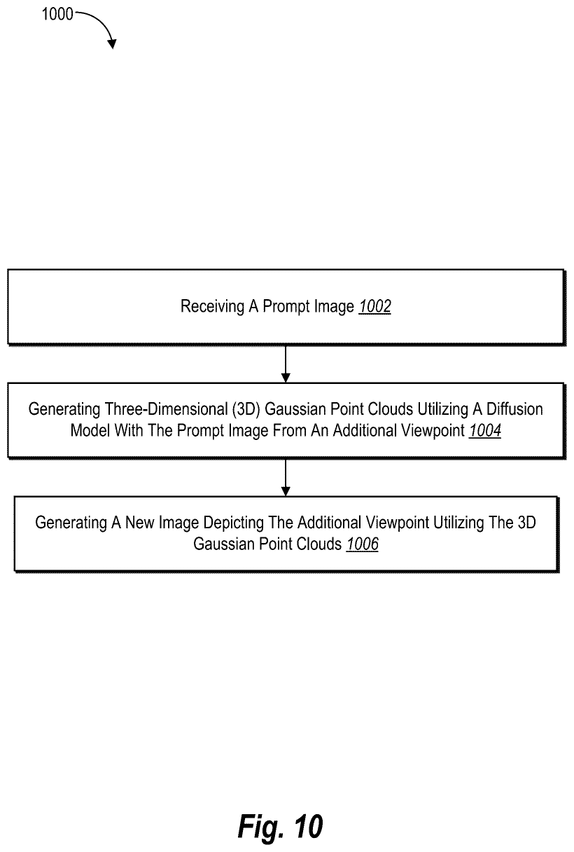

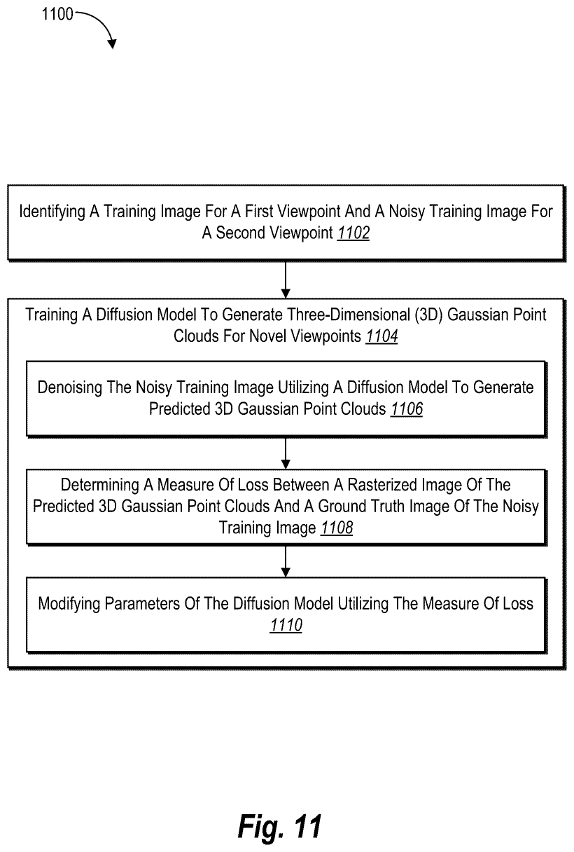

FIGS. 1-9, the corresponding text, and the examples provide a number of different methods, systems, devices, and non-transitory computer-readable media of the digital image-to-3D generation system 106. In addition to the foregoing, one or more embodiments are also describable in terms of flowcharts comprising acts for accomplishing a particular result, as shown in FIGS. 10 and 11. The acts shown in FIGS. 10 and 11 may be performed in connection with more or fewer acts. Further, the acts may be performed in differing orders. Additionally, the acts described herein may be repeated or performed in parallel with one another or parallel with different instances of the same or similar acts. A non-transitory computer-readable medium comprises instructions that, when executed by one or more processors, cause a computing device to perform the acts of FIGS. 10 and 11. In some embodiments, a system is configured to perform the acts of FIGS. 10 and 11. Alternatively, the acts of FIGS. 10 and 11 are performed as part of a computer implemented method.

As mentioned above, FIG. 10 illustrates a flowchart of a series of acts 1000 for utilizing a diffusion model to generate 3D Gaussians representing a novel view of a prompt image in accordance with one or more implementations. While FIG. 10 illustrates acts according to one embodiment, alternative embodiments may omit, add to, reorder, and/or modify any of the acts shown in FIG. 10. For instance, as shown in FIG. 10, the series of acts 1000 include an act 1002 of receiving a prompt image, an act 1004 of generating three-dimensional (3D) Gaussian point clouds utilizing a diffusion model with the prompt image from an additional viewpoint, and an act 1006 of generating a new image depicting the additional viewpoint utilizing the 3D Gaussian point clouds.

In one or more instances, the series of acts 1000 include receiving a prompt image depicting a visual entity from a first viewpoint, generating, utilizing a diffusion model with an input camera condition and the prompt image, three-dimensional (3D) Gaussian point clouds representing the visual entity from a second viewpoint, and utilizing the 3D Gaussian point clouds to generate a new image depicting the visual entity from the second viewpoint.

In some cases, the series of acts 1000 include receiving a prompt image depicting a visual entity from a first viewpoint and an input camera condition and generating three-dimensional (3D) Gaussian point clouds representing the visual entity from a second viewpoint by generating a noisy prompt image from the prompt image and generating the 3D Gaussian point clouds representing the visual entity from the second viewpoint from denoising the noisy prompt image utilizing the diffusion model conditioned on input camera condition.

In some cases, the series of acts 1000 include generating the 3D Gaussian point clouds by utilizing the diffusion model to diffuse noisy pixels, from a noisy image corresponding to the prompt image, into the 3D Gaussian point clouds conditioned on the input camera condition. In addition, in some implementations, the series of acts 1000 include generating the 3D Gaussian point clouds by utilizing the diffusion model to diffuse noisy pixels from the noisy image at a plurality of timesteps of the diffusion model.

Moreover, in some instances, the series of acts 1000 include generating a 3D Gaussian point cloud to represent a position, covariances controlling shapes, an opacity, and colors of the visual entity from the second viewpoint.

In some instances, the series of acts 1000 include determining the input camera condition by identifying a position and a direction for a ray corresponding to the second viewpoint and determining a reference point coordinate based on a coordinate point on the ray nearest to an origin point of a world coordinate system of the prompt image. Indeed, in some cases, the series of acts 1000 include identifying the input camera condition from a ray corresponding to the second viewpoint based on a nearest coordinate point on the ray nearest to an origin point of a world coordinate system of the prompt image.

Moreover, in one or more cases, the series of acts 1000 include generating the new image depicting the visual entity from the second viewpoint by rasterizing the 3D Gaussian point clouds.

Additionally, in one or more embodiments, the series of acts 1000 include training the diffusion model utilizing a first set of training images depicting scene-level entities and a second set of training images depicting object-level entities. For example, the series of acts 1000 include selecting viewpoints from the first set of training images and the second set of training images utilizing a viewpoint angle constraint for camera position or camera orientation. Moreover, in some cases, the series of acts 1000 include utilizing a point distribution loss to modify parameters of the diffusion model for distribution of 3D Gaussian point cloud concentration.

In addition, in one or more cases, the series of acts 1000 include identifying an additional input camera condition representing a third viewpoint and generating additional 3D Gaussian point clouds representing the visual entity from the third viewpoint from denoising the noisy prompt image utilizing the diffusion model conditioned on the additional input camera condition.

Moreover, in some instances, the series of acts 1000 include utilizing the 3D Gaussian point clouds to generate a new image depicting the object or the scene from the second viewpoint. For instance, the prompt image depicts an object or a scene.

Additionally, FIG. 11 illustrates a flowchart of a series of acts 1100 for training a diffusion model to generate 3D Gaussian point clouds in accordance with one or more implementations. While FIG. 11 illustrates acts according to one embodiment, alternative embodiments may omit, add to, reorder, and/or modify any of the acts shown in FIG. 11. For instance, as shown in FIG. 11, the series of acts 1100 include an act 1102 of identifying a training image for a first viewpoint and a noisy training image for a second viewpoint and an act 1104 of training a diffusion model to generate the three-dimensional (3D) Gaussian point clouds for novel viewpoints through an act 1106 of denoising the noisy training image utilizing a diffusion model to generate predicted 3D Gaussian point clouds, an act 1108 of determining a measure of loss between a rasterized image of the predicted 3D Gaussian point clouds and a ground truth image of the noisy training image, and an act 1110 of modifying parameters of the diffusion model utilizing the measure of loss.

In some instances, the series of acts 1100 include identifying a training image depicting a visual entity from a first viewpoint and a noisy training image depicting the visual entity from a second viewpoint and training a diffusion model to generate three-dimensional (3D) Gaussian point clouds representing the visual entity from novel viewpoints by denoising the noisy training image utilizing the diffusion model to generate predicted 3D Gaussian point clouds depicting the visual entity from the second viewpoint, determining a measure of loss between a rasterized image of the predicted 3D Gaussian point clouds depicting the visual entity from the second viewpoint and a ground truth image corresponding to the noisy training image, and modifying parameters of the diffusion model utilizing the measure of loss.

Moreover, in some cases, the series of acts 1100 include training a first neural network component of the diffusion model from the training image to generate the 3D Gaussian point clouds representing a scene-level entity from novel viewpoints, identifying an additional training image depicting an object-level entity from a third viewpoint, and training a second neural network component of the diffusion model from the additional training image to generate additional 3D Gaussian point clouds representing an object-level entity from additional novel viewpoints.

Furthermore, in some instances, the series of acts 1100 include selecting the first viewpoint and the second viewpoint of the training image utilizing a viewpoint angle constraint for camera position or camera orientation.

Additionally, in some implementations, the series of acts 1100 include determining an input camera condition from a ray corresponding to the second viewpoint based on a nearest coordinate point on the ray nearest to an origin point of a world coordinate system and denoising the noisy training image utilizing the diffusion model with the input camera condition.

In addition, in some cases, the series of acts 1100 include determining the measure of loss as a point distribution loss to control a distribution of 3D Gaussian point cloud concentration.

Furthermore, in one or more implementations, the series of acts 1100 include denoising the noisy training image utilizing the diffusion model to generate the predicted 3D Gaussian point clouds at a plurality of timesteps of the diffusion model.

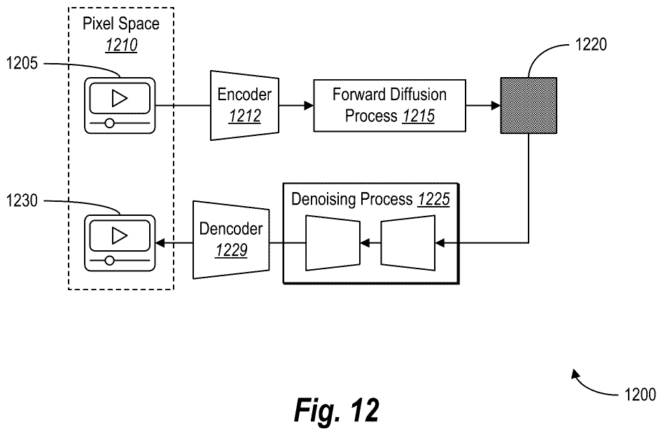

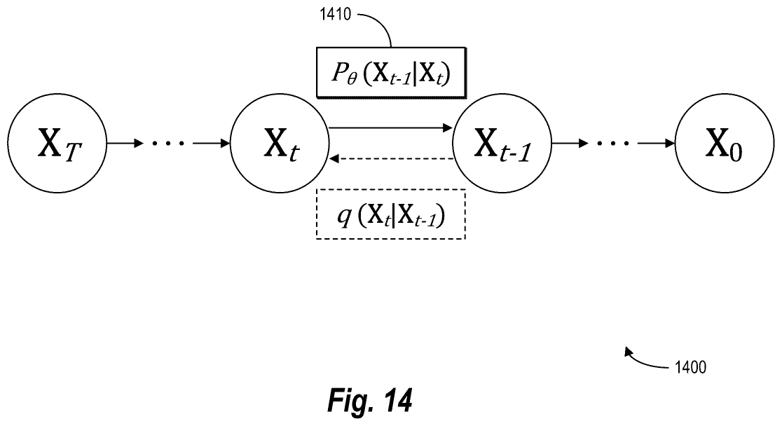

FIG. 12 shows an example of a diffusion model 1200 according to aspects of the present disclosure. In some examples, a diffusion model 1200 describes the operation and architecture of the diffusion transformer model (e.g., single stream diffusion transformer model described above) described with reference to FIG. 14. The diffusion model depicted in FIG. 12 is an example of, or includes aspects of, a digital image-to-3D generation system 106 as described herein. Specifically, a diffusion transformer model combines principles of diffusion models with principles of transformer models. Accordingly, FIG. 12 shows the digital image-to-3D generation system 106 initializing a trained diffusion transformer model by leveraging a forward diffusion process to destroy data and then creating media from the destroyed data using a denoising process. In other words, the digital image-to-3D generation system 106 teaches a diffusion transformer model to create generative content from noise using a forward diffusion process and a denoising process.

As an example, diffusion models are generative models that operate by progressively destroying/noising an input signal and learning to reverse the destroyed data to generate new samples. In particular, diffusion models use a forward diffusion process to add noise over a series of timesteps and a reverse diffusion process to remove noise over a number of timesteps corresponding to the forward number of steps.

As a further example, transformer models are designed for sequence-to-sequence modeling tasks (e.g., tasks that generate based on a sequential order, such as generative tasks that leverage tokens). As mentioned above, transformer models typically include self-attention mechanisms, and multi-layer perceptrons (e.g., feedforward networks to move the data through a transformer architecture). Moreover, transformer architecture typically considers positional information such as the positional encodings discussed above.

With the context of diffusion models and transformer models discussed above, additional details of how diffusion transformer models meld principles from diffusion models and transformer models together are provided herein. Diffusion transformer models are a class of generative neural networks which can be trained to generate new data with features similar to features found in training data. In particular, diffusion transformer models can be used to generate novel media items such as images, audio files, videos, three-dimensional (3D) models or other digital media items. Diffusion transformer models can be used for various media processing tasks including image super-resolution, generation of media items with perceptual metrics, image inpainting, and media manipulation. In particular, the diffusion transformer models differ from existing diffusion model architecture in that it combines transformer architecture with diffusion principles of removing noise from noised tokens. Specifically, the architecture of a diffusion transformer model in the present disclosure includes a self-attention layer and a multi-layer perceptron. In one or more embodiments, the diffusion transformer model does not include conditioning inputs, rather, position encodings and other (clean) tokens (such as anchor tokens) are included with noised tokens as guidance for how a transformer block should remove noise from a noised token.

In one or more embodiments, the diffusion transformer models leverage the architecture of a transformer model to capture long-range dependencies and complex structures in high-dimensional data. Specifically, the diffusion transformer models operate by processing token data of images and text to fully consider the long-range dependencies. Moreover, the diffusion transformer models use the transformer architecture to predict the denoised data at each timestep (e.g., transformer block) and as discussed above, uses a self-attention mechanism to the noised data to understand how noise should be removed across various noised input tokens.

As discussed in detail above, the digital image-to-3D generation system 106 utilizes a diffusion transformer model (rather than UNet diffusion architecture) where the digital image-to-3D generation system 106 leverages encoders (e.g., VAE encoders) to abstract pixel details into latent representations (e.g., embeddings). For instance, the digital image-to-3D generation system 106 utilizes encoders to abstract pixel data into semantic information which is adaptable for use in a transformer architecture (e.g., a transformer architecture captures global context through attention from the latent representations).

Moreover, in one or more embodiments, rather than injecting diffusion information through an adaLN modulation, the digital image-to-3D generation system 106 designs a diffusion transformer model a single stream manner. In other words, the digital image-to-3D generation system 106 utilizes a diffusion transformer model with inputs flowing in and inputs flowing out in a single stream. Thus, in one or more embodiments, the digital image-to-3D generation system 106 does not utilize adaLN modulation for conditioning inputs, and directly feeds positional encodings, anchor tokens, and/or other encoding information (e.g., token-level diffusion timestep embedding) into a self-attention layer along with nosed tokens.

In one or more embodiments, methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

In one or more embodiments, the digital image-to-3D generation system 106 utilizes a diffusion process to adds noise to data 1205 to media that has been transformed from a pixel space 1210 to a latent space. For instance, the digital image-to-3D generation system 106 transforms the data 1205 to the latent space, adds noise to the data 1205 and then denoises noised data 1220 using transformer blocks (e.g., removes noise from the noised tokens to obtain a synthetic media item). Specifically, FIG. 12 shows the data 1220 (e.g., a visual prompt) being processed by an encoder 1212 (e.g., to generate embeddings and then to further generate tokens).

Furthermore, FIG. 12 shows the digital image-to-3D generation system 106 utilizing a forward diffusion process 1215 to add noise to the data 1205. Moreover, FIG. 12 shows the digital image-to-3D generation system 106 utilizing a denoising process 1225 to remove noise from noised data 1220. For instance, FIG. 12 shows the digital image-to-3D generation system 106 utilizing a decoder 1229 to generate media 1230. Further, in one or more embodiments, the digital image-to-3D generation system 106 adds noise to data in a progressive manner (e.g., over a number of timesteps corresponding to a number of transformer blocks). In doing so, the digital image-to-3D generation system 106 trains a diffusion transformer model to create generative content from destroyed data (e.g., the noised data 1220).

As just mentioned, FIG. 12 shows the data 1220 being processed by the encoder 1212. As is discussed in some detail above, the diffusion transformer model operates by processing token-level data. To do so, the digital image-to-3D generation system 106 uses the encoder 1212 to generate embedding(s) of the data 1220 and further transforms the data 1220 into tokens. For instance, the transformation process is referred to as tokenization or patchification. Specifically, tokenization/patchification starts with an image with dimensions of H×W×C, where H is the height, W is the width, and C is the number of color channels (3 for RGB images).

In one or more embodiments, the digital image-to-3D generation system 106 uses patchification to divide the image into patches (e.g., partition the image into non-overlapping patches of size P×P) where each patch contains P×P×C pixel values. Further, for an image of size H×W, the total number of patches will be (H/P)×(W/P). Furthermore, the digital image-to-3D generation system 106 flattens the image patches into a one-dimensional vector to create a sequence of patch embeddings analogous to text tokens (e.g., in context of natural language processing).

Furthermore, the digital image-to-3D generation system 106 generates an image token by performing a linear projection to transform an image patch into a fixed-dimensional embedding (d-dimensional vector). In particular, the generated image tokens act as input tokens for the diffusion transformer model.

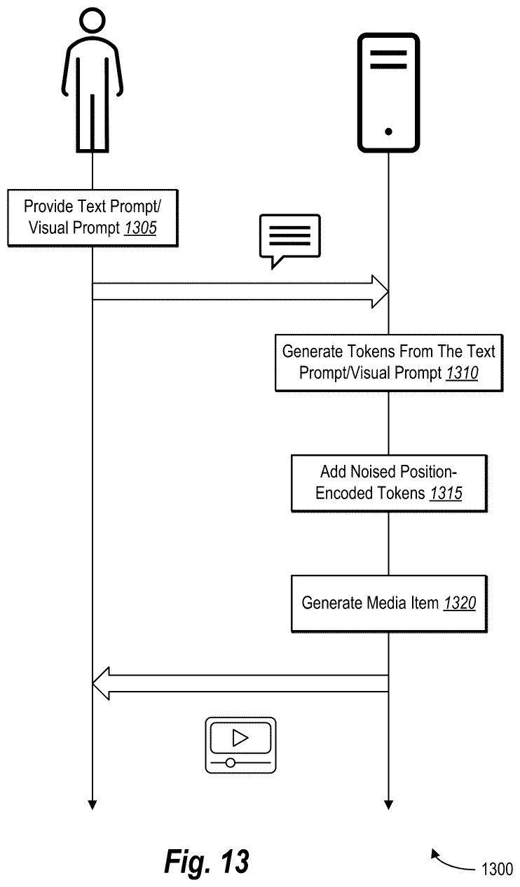

FIG. 13 shows an example of a method 1300 for media generation according to aspects of the present disclosure. In some examples, method 1300 describes an operation of the diffusion transformer model such as an application of the diffusion model 1200 described with reference to FIG. 12. In some examples, these operations are performed by a system including a processor executing a set of codes to control functional elements of an apparatus such as the digital image-to-3D generation system 106 described above.

Additionally, or alternatively, steps of the method 1300 may be performed using special-purpose hardware. Generally, these operations are performed according to the methods and processes described in accordance with aspects of the present disclosure. In some cases, the operations described herein are composed of various substeps or are performed in conjunction with other operations.

At operation 1305, a user provides a text and/or visual prompt describing content to be included in a generated media item. For example, a user may provide the prompt “a person playing with a cat”. In some examples, guidance can be provided in a form other than text, such as via an image (e.g., a visual prompt), a sketch, an audio input, or a layout.

At operation 1310, the system converts the text prompt (or other prompt guidance) into tokens or other multi-dimensional representation compatible with a single stream diffusion transformer model. For example, text may be converted into a vector or a series of vectors using a transformer model, or a multi-modal encoder.

At operation 1315, a noise map is initialized that includes random noise. The noise map may be in a pixel space or a latent space. By initializing a media item with random noise, different variations of a media item including the content described by the prompt can be generated. At operation 1320, the system generates a media item based on the noise map, tokens from the prompt (e.g., text prompt and/or visual prompt), and additional spatial-temporal positional encodings.

FIG. 14 shows a diffusion process 1400 according to aspects of the present disclosure. Specifically, FIG. 14 provides additional details of operating principles for a diffusion model. Accordingly, FIG. 14 provides context and details for the principles borrowed from diffusion models to help operate diffusion transformer models. In some examples, diffusion process 1400 describes an operation of the diffusion transformer model, such as the denoising process of a diffusion model 1200 described with reference to FIG. 12.

As described above with reference to FIG. 12, using a diffusion transformer model can involve a process for initializing noise (e.g., generating noised tokens in a latent space) and a denoising process 1410 for denoising the noised tokens to obtain denoised tokens. The denoising process 1410 can be represented as p (xₜ₋₁|xₜ). In some cases, a neural network is trained to perform the denoising process 1410 (i.e., to successively remove the noise).

In an example forward process for a latent diffusion model, the model maps an observed variable x₀ (an embedding in a latent space) intermediate variables x₁, . . . , x_{T} using a Markov chain. The Markov chain gradually adds Gaussian noise to the data (e.g., the embedding, such as a visual signal) to obtain the approximate posterior q(x_{1:T}|x₀) as the latent variables are passed through a neural network such as a diffusion transformer model, where x₁, . . . , x_{T} have the same dimensionality as x₀.

The neural network may be trained to perform the denoising process. During the denoising process 1410, the model begins with noisy data x_{T}, such as a noisy token and denoises the data to obtain the p (xₜ₋₁|xₜ). At each step t−1, the denoising process 1410 takes xₜ, such as first intermediate denoised token, spatial-temporal positional encodings, and tokens (e.g., representing a prompt). Here, t represents a transformer block in a sequence of transformer blocks associated with different noise levels, The denoising process 1410 outputs xₜ₋₁, such as second intermediate denoised token iteratively until x_{T} reverts back to x₀, a completely denoised token. The denoising process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

Moreover, the process of adding noise to data to generate noised tokens is expressed as the joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data ã is mapped back into the pixel space from the latent space as output (e.g., using a decoder of a trained dual-VAE model). In some examples, x₀ represents an original clean token, latent variables x₁, . . . , x_{T} represent noisy tokens, and \tilde{x} represents the generated item with high quality.

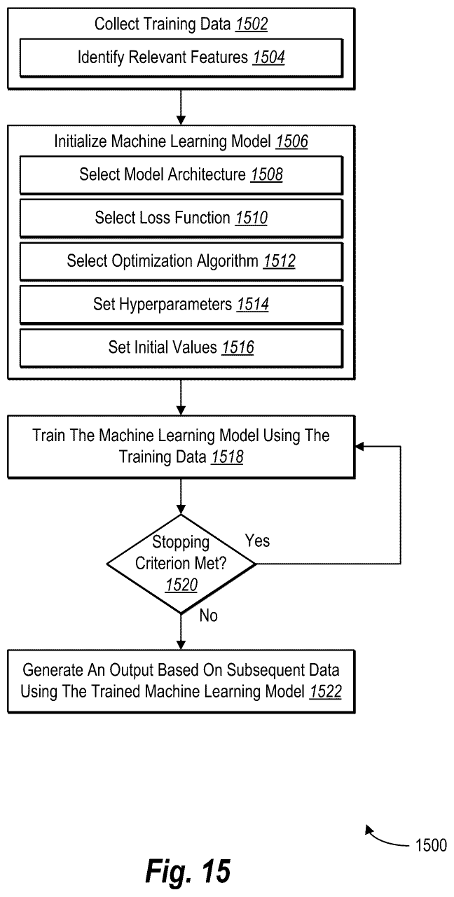

FIG. 15 is a flow diagram depicting an algorithm as a step-by-step procedure 1500 in an example implementation of operations performable for training a machine-learning model. In one or more embodiments, the procedure 1500 describes an operation of the training component described for configuring a diffusion transformer model. The procedure 1500 provides one or more examples of generating training data, use of the training data to train a machine-learning model, and use of the trained machine-learning model to perform a task.

To begin in this example, a machine-learning system collects training data (block 1502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1506). Initialization of the machine-learning model includes selecting a model architecture (block 1508) to be trained. Examples of model architectures include neural networks, diffusion transformer models, transformer models, diffusion models, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1510). The loss function is utilized to measure a difference between an output of the machine-learning model (i.e., predictions) and target values (e.g., as expressed by the training data) to be used to train the machine-learning model. Additionally, an optimization algorithm 1512 is selected that is to be used in conjunction with the loss function to optimize parameters of the machine-learning model during training, examples of which include gradient descent, stochastic gradient descent (SGD), and so forth.

Initialization of the machine-learning model further includes setting initial values (block 1516) of the machine-learning model (block 1514) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), the procedure 1500 continues training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore once trained is configured to perform that task based on subsequent data received as an input and processed by the machine-learning model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

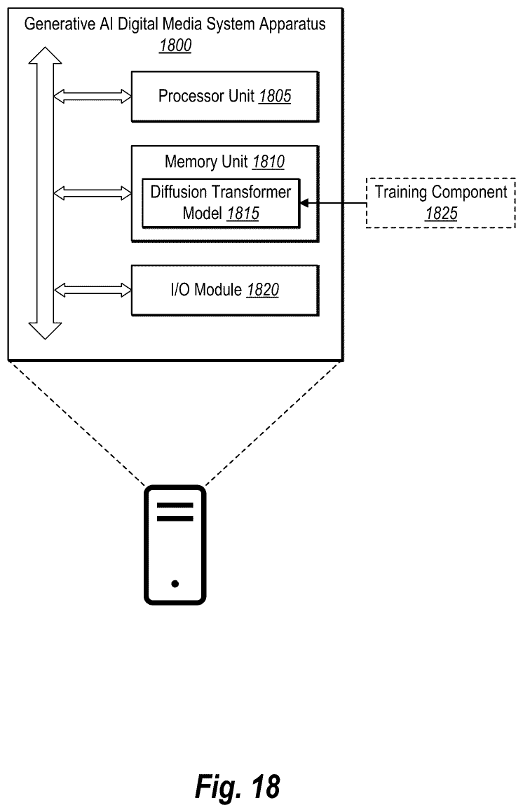

FIG. 16 shows an example of a method 1600 for training a diffusion model according to aspects of the present disclosure. In some embodiments, the method 1600 describes an operation of a training component described for configuring a diffusion transformer model as described with reference to FIG. 18. The method 1600 represents an example for training a reverse diffusion process as described above with reference to FIG. 14. In some examples, these operations are performed by a system including a processor executing a set of codes to control functional elements of an apparatus, such as the guided diffusion model described in FIG. 12.

Additionally, or alternatively, certain processes of method 1600 may be performed using special-purpose hardware. Generally, these operations are performed according to the methods and processes described in accordance with aspects of the present disclosure. In some cases, the operations described herein are composed of various substeps or are performed in conjunction with other operations.

At operation 1605, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1610, the system adds noise to a media item using a forward diffusion process in N stages. In some cases, the forward diffusion process is a fixed process where Gaussian noise is successively added to media item. In latent diffusion models (e.g., the token space), the Gaussian noise may be successively added to features in a latent space.

At operation 1615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1625, the system updates parameters of the model based on the comparison. For example, parameters of a U-Net may be updated using gradient descent. Time-dependent parameters of the Gaussian transitions can also be learned. However, in some embodiments, for the diffusion transformer model, the system updates parameters of each transformer block using a mean square error denoising loss.

FIG. 17 shows an example of a computing device 1700 according to aspects of the present disclosure. The computing device 1700 may be an example of the generative AI digital media system apparatus (e.g., an apparatus for interacting with the digital image-to-3D generation system 106, which is described above). In one aspect, computing device 1700 includes processor(s) 1705, memory subsystem 1710, communication interface 1715, I/O interface 1720, user interface component(s) 1725, and channel 1730.

In one or more embodiments, computing device 1700 is an example of, or includes aspects of, the digital image-to-3D generation system 106 described above. In one or more embodiments, computing device 1700 includes one or more processors 1705 that can execute instructions stored in memory subsystem 1710 to perform media generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In one or more embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1620 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

FIG. 18 shows an example of a generative AI digital media system apparatus 1800 according to aspects of the present disclosure. generative AI digital media system apparatus 1800 may include an example of, or aspects of, the diffusion model described with reference to FIG. 12. In one or more embodiments, generative AI digital media system apparatus 1800 includes processor unit 1805, memory unit 1810, diffusion transformer model 1815, I/O module 1820, and training component 1825. Training component 1825 updates parameters of the diffusion transformer model 1815 stored in memory unit 1810. In some examples, the training component 1825 is located outside the generative AI digital media system apparatus 1800.

Processor unit 1805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1805 is configured to operate a memory array using a memory controller. In other cases, a memory controller is integrated into processor unit 1805. In some cases, processor unit 1805 is configured to execute computer-readable instructions stored in memory unit 1810 to perform various functions. In some aspects, processor unit 1805 includes special purpose components for modem processing, baseband processing, digital signal processing, or transmission processing. According to some aspects, processor unit 1805 comprises one or more processors described with reference to FIG. 17.

Memory unit 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1805 to perform various functions described herein.

In some cases, memory unit 1810 includes a basic input/output system (BIOS) that controls basic hardware or software operations, such as an interaction with peripheral components or devices. In some cases, memory unit 1810 includes a memory controller that operates memory cells of memory unit 1810. For example, the memory controller may include a row decoder, column decoder, or both. In some cases, memory cells within memory unit 1810 store information in the form of a logical state. According to some aspects, memory unit 1810 is an example of the memory subsystem 1710 described with reference to FIG. 17.

According to some aspects, generative AI digital media system apparatus 1800 uses one or more processors of processor unit 1805 to execute instructions stored in memory unit 1810 to perform functions described herein. For example, the generative AI digital media system apparatus to perform the operations described in the aspects below.

The memory unit 1810 may include a diffusion transformer model 1815 trained to remove noise from noised tokens according to spatial-temporal positional encodings. For example, after training, the diffusion transformer model 1815 may perform inferencing operations as described with reference to FIGS. 12-13 to remove noise from noised tokens and generate media such as point clouds and images.

In one or more embodiments, the diffusion transformer model 1815 is an Artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. Specifically, each transformer block of the diffusion transformer model 1815 can represent the connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model. Accordingly, the multi-layer perceptrons within each transformer block of the diffusion transformer model represents various aspects of an ANN.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the diffusion transformer model 1815 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1825 may train the diffusion transformer model 1815. For example, parameters of the diffusion transformer model 1815 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion transformer model 1815 can be used to make predictions on new, unseen data (i.e., during inference).

I/O module 1820 receives inputs from and transmits outputs of the generative AI digital media system apparatus 1800 to other devices or users. For example, I/O module 1820 receives inputs for the diffusion transformer model 1815 and transmits outputs of the diffusion transformer model 1815. According to some aspects, I/O module 1820 is an example of the I/O interface 1720 described with reference to FIG. 17.

What is claimed is:

1. A non-transitory computer-readable medium storing executable instructions which, when executed by a processing device, cause the processing device to perform operations comprising:
receiving a prompt image depicting a visual entity from a first viewpoint;
generating, utilizing a diffusion model with an input camera condition and the prompt image, three-dimensional (3D) Gaussian point clouds representing the visual entity from a second viewpoint; and
utilizing the 3D Gaussian point clouds to generate a new image depicting the visual entity from the second viewpoint.

2. The non-transitory computer-readable medium of claim 1, wherein the operations further comprise generating the 3D Gaussian point clouds by utilizing the diffusion model to diffuse noisy pixels, from a noisy image corresponding to the prompt image, into the 3D Gaussian point clouds conditioned on the input camera condition.

3. The non-transitory computer-readable medium of claim 2, wherein the operations further comprise generating the 3D Gaussian point clouds by utilizing the diffusion model to diffuse noisy pixels from the noisy image at a plurality of timesteps of the diffusion model.

4. The non-transitory computer-readable medium of claim 1, wherein the operations further comprise generating a 3D Gaussian point cloud to represent a position, covariances controlling shapes, an opacity, and colors of the visual entity from the second viewpoint.

5. The non-transitory computer-readable medium of claim 1, wherein the operations further comprise determining the input camera condition by:
identifying a position and a direction for a ray corresponding to the second viewpoint; and
determining a reference point coordinate based on a coordinate point on the ray nearest to an origin point of a world coordinate system of the prompt image.

6. The non-transitory computer-readable medium of claim 1, wherein the operations further comprise generating the new image depicting the visual entity from the second viewpoint by rasterizing the 3D Gaussian point clouds.

7. The non-transitory computer-readable medium of claim 1, wherein the operations further comprise training the diffusion model utilizing a first set of training images depicting scene-level entities and a second set of training images depicting object-level entities.

8. The non-transitory computer-readable medium of claim 7, wherein the operations further comprise selecting viewpoints from the first set of training images and the second set of training images utilizing a viewpoint angle constraint for camera position or camera orientation.

9. The non-transitory computer-readable medium of claim 7, wherein the operations further comprise utilizing a point distribution loss to modify parameters of the diffusion model for distribution of 3D Gaussian point cloud concentration.

10. A system comprising:
a memory component comprising a diffusion model; and
a processing device coupled to the memory component, wherein the processing device is configured to perform operations comprising:
receiving a prompt image depicting a visual entity from a first viewpoint and an input camera condition; and
generating three-dimensional (3D) Gaussian point clouds representing the visual entity from a second viewpoint by:
generating a noisy prompt image from the prompt image; and
generating the 3D Gaussian point clouds representing the visual entity from the second viewpoint from denoising the noisy prompt image utilizing the diffusion model conditioned on input camera condition.

11. The system of claim 10, wherein the operations further comprise identifying the input camera condition from a ray corresponding to the second viewpoint based on a nearest coordinate point on the ray nearest to an origin point of a world coordinate system of the prompt image.

12. The system of claim 10, wherein the operations further comprise generating a new image depicting the visual entity from the second viewpoint by rasterizing the 3D Gaussian point clouds.

13. The system of claim 10, wherein the operations further comprise:
identifying an additional input camera condition representing a third viewpoint; and
generating additional 3D Gaussian point clouds representing the visual entity from the third viewpoint from denoising the noisy prompt image utilizing the diffusion model conditioned on the additional input camera condition.

14. The system of claim 10, wherein the prompt image depicts an object or a scene from the first viewpoint and the operations further comprise utilizing the 3D Gaussian point clouds to generate a new image depicting the object or the scene from the second viewpoint.

15. A computer-implemented method comprising:
identifying a training image depicting a visual entity from a first viewpoint and a noisy training image depicting the visual entity from a second viewpoint; and
training a diffusion model to generate three-dimensional (3D) Gaussian point clouds representing the visual entity from novel viewpoints by:
denoising the noisy training image utilizing the diffusion model to generate predicted 3D Gaussian point clouds depicting the visual entity from the second viewpoint;
determining a measure of loss between a rasterized image of the predicted 3D Gaussian point clouds depicting the visual entity from the second viewpoint and a ground truth image corresponding to the noisy training image; and
modifying parameters of the diffusion model utilizing the measure of loss.

16. The computer-implemented method of claim 15, further comprising:
training a first neural network component of the diffusion model from the training image to generate the 3D Gaussian point clouds representing a scene-level entity from novel viewpoints;
identifying an additional training image depicting an object-level entity from a third viewpoint; and
training a second neural network component of the diffusion model from the additional training image to generate additional 3D Gaussian point clouds representing an object-level entity from additional novel viewpoints.

17. The computer-implemented method of claim 15, further comprising selecting the first viewpoint and the second viewpoint of the training image utilizing a viewpoint angle constraint for camera position or camera orientation.

18. The computer-implemented method of claim 15, further comprising:
determining an input camera condition from a ray corresponding to the second viewpoint based on a nearest coordinate point on the ray nearest to an origin point of a world coordinate system; and
denoising the noisy training image utilizing the diffusion model with the input camera condition.

19. The computer-implemented method of claim 15, further comprising determining the measure of loss as a point distribution loss to control a distribution of 3D Gaussian point cloud concentration.

20. The computer-implemented method of claim 15, further comprising denoising the noisy training image utilizing the diffusion model to generate the predicted 3D Gaussian point clouds at a plurality of timesteps of the diffusion model.
